(19) United States
(12) Patent Application Publication
(10) Pub. No.: US 2025/0037345 A1
(43) Pub. Date: Jan. 30, 2025

(54) SYNCHRONOUS CHARACTER DISPLAY

(71) Applicant: Tencent Technology (Shenzhen) Company Limited, Shenzhen (CN)

(72) Inventors: Xuanneng LI, Shenzhen (CN); Yongyuan CHENG, Shenzhen (CN); Zhi LI, Shenzhen (CN); Wenkai HAN, Shenzhen (CN); Huahao LIU, Shenzhen (CN); Chong ZHANG, Shenzhen (CN); Cheng ZHOU, Shenzhen (CN)

(73) Assignee: Tencent Technology (Shenzhen) Company Limited, Shenzhen (CN)

(21) Appl. No.: 18/913,950

(22) Filed: Oct. 11, 2024

Related U.S. Application Data
(63) Continuation of application No. PCT/CN2023/109279, filed on Jul. 26, 2023.

(30) Foreign Application Priority Data
Sep. 6, 2022 (CN) 202211084319.8

(51) Int. Cl. G06T 13/80; G06T 7/246

(52) U.S. Cl. CPC G06T 13/80; G06T 7/246

(57) ABSTRACT

In a method for synchronizing character display, motion data of a first character over a time period is obtained. A first phase parameter for the first character at an end of the time period is determined based on the motion data and a standard action cycle for a current action that is performed by the first character. A second phase parameter from the second terminal is received. The first phase parameter is adjusted based on the second phase parameter to obtain a third phase parameter. Updated motion data for the first character is generated based on the third phase parameter. The first character is displayed based on the updated motion data.

### RELATED APPLICATIONS

The present application is a continuation of International Application No. PCT/CN2023/109279, filed on Jul. 26, 2023, which claims priority to Chinese Patent Application No. 202211084319.8, filed on Sep. 6, 2022. The entire disclosures of the prior applications are hereby incorporated by reference.

### FIELD OF THE TECHNOLOGY

Embodiments of this application relate to the field of computer technologies, including a synchronous character display.

### BACKGROUND OF THE DISCLOSURE

With the development of sciences and technologies, various modes such as office, education, and entertainment are gradually moving online, and the demand for character synchronization such as video conferencing, video broadcasting, and animation synchronization has become more widespread and intense. In the above scenarios, information sharing technologies involving high quality and high precision are attracting much attention.

In related technologies, when character synchronization is performed, a main control terminal usually obtains action data corresponding to a video screen of a character and then sends the action data to a simulation terminal. The simulation terminal parses the action data, then directly generates a synchronization screen of the character based on the action data, and displays the synchronization screen of the character, to implement a process of synchronous character display.

However, in the above process, if the simulation terminal directly generates a synchronization screen of the character based on the action data and displays it on an interface of the simulation terminal, sometimes the synchronization screen changes greatly at the moment of update because the difference between the received action data and the action data corresponding to the current playback screen is too large, ignoring the smoothness of synchronous character display.

### SUMMARY

Embodiments of this disclosure include a synchronous character display method, and apparatus to more fully use a characteristic that a first character and a second character have the same action cycle, and make transition between action screens of the first character smoother. Examples of technical solutions in the embodiments of this disclosure may be implemented as follows:

An aspect of this disclosure provides a method for synchronizing character display. Motion data of a first character over a time period is obtained. The first character is displayed by a first terminal in synchronization with a second character controlled by a second terminal. A first phase parameter for the first character at an end of the time period is determined based on the motion data and a standard action cycle for a current action that is performed by the first character. The standard action cycle indicates a complete sequence of motions for a specific action, and the first phase parameter indicates a state feature corresponding to an action presentation of the first character at the end of the time period within the standard action cycle. A second phase parameter from the second terminal is received. The second phase parameter corresponds to the second character at the end of the time period. The second phase parameter indicates the state feature corresponding to the action presentation of the second character within the standard action cycle at the end of the time period. The first phase parameter is adjusted based on the second phase parameter to obtain a third phase parameter. Updated motion data for the first character is generated based on the third phase parameter. The first character is displayed based on the updated motion data.

Another aspect of this disclosure provides a method for synchronizing character display. Motion data of a second character over a time period is obtained. A second phase parameter for the second character at an end of the time period is determined based on the motion data and a standard action cycle for a current action that is performed by the second character. The second phase parameter is transmitted to a first terminal. The first terminal adjusts a first phase parameter based on the second phase parameter to synchronize display of a first character corresponding to the second character.

An aspect of this disclosure provides an apparatus, including processing circuitry. The processing circuitry is configured to obtain motion data of a first character over a time period. The first character is displayed by a first terminal in synchronization with a second character controlled by a second terminal. The processing circuitry is configured to determine a first phase parameter for the first character at an end of the time period based on the motion data and a standard action cycle for a current action that is performed by the first character. The standard action cycle indicates a complete sequence of motions for a specific action. The first phase parameter indicates a state feature corresponding to an action presentation of the first character at the end of the time period within the standard action cycle. The processing circuitry is configured to receive a second phase parameter from the second terminal. The second phase parameter corresponds to the second character at the end of the time period. The second phase parameter indicates the state feature corresponding to the action presentation of the second character within the standard action cycle at the end of the time period. The processing circuitry is configured to adjust the first phase parameter based on the second phase parameter to obtain a third phase parameter. The processing circuitry is configured to generate updated motion data for the first character based on the third phase parameter. The processing circuitry is configured to display the first character based on the updated motion data.

The technical solutions provided in the embodiments of this disclosure can have the following beneficial effects:

Simulation attitude data of a first character in a historical period of time is obtained, and a first cycle parameter of the first character at a termination moment of the historical period of time is obtained in combination with a motion status of the first character in a standard action cycle of a current action; correction and adjustment are performed on the first cycle parameter based on a second cycle parameter transmitted by a second terminal, to obtain a third cycle parameter; updated attitude data is generated based on the third cycle parameter; and the first character corresponding to a second character is displayed according to the updated attitude data.

Through the foregoing method, the motion status of the first character in the standard action cycle of the current action can be considered, and the characteristic that the first character and the second character have the same action cycle can be fully used. The first cycle parameter is adjusted on the first terminal based on the second cycle parameter, to make transition between action screens of the first character smoother.

In addition, the second terminal transmits the second cycle parameter to the first terminal, and the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

### BRIEF DESCRIPTION OF THE DRAWINGS

FIG. 1 is a schematic diagram of an implementation environment according to an embodiment of this disclosure.

FIG. 2 is a flowchart of a synchronous character display method according to an embodiment of this disclosure.

FIG. 3 is a schematic diagram of determining a standard action cycle according to an embodiment of this disclosure.

FIG. 4 is a schematic diagram of determining a standard action cycle according to another embodiment of this disclosure.

FIG. 5 is a flowchart of a synchronous character display method according to another embodiment of this disclosure.

FIG. 6 is a flowchart of a synchronous character display method according to still another embodiment of this disclosure.

FIG. 7 is a flowchart of a synchronous character display method performed by a main control terminal according to an embodiment of this disclosure.

FIG. 8 is a flowchart of a synchronous character display method performed by a simulation terminal according to an embodiment of this disclosure.

FIG. 9 is a schematic diagram of interaction between a main control terminal and a simulation terminal according to an embodiment of this disclosure.

FIG. 10 is a structural block diagram of a synchronous character display apparatus according to an embodiment of this disclosure.

FIG. 11 is a structural block diagram of a synchronous character display apparatus according to another embodiment of this disclosure.

FIG. 12 is a structural block diagram of a terminal according to an embodiment of this disclosure.

### DESCRIPTION OF EMBODIMENTS

First, terms involved in the embodiments of this disclosure are briefly introduced. The descriptions of the terms are provided as examples only and are not intended to limit the scope of the disclosure.

Character motion animation: In computer games, computer virtual reality applications, or animated videos, character animation means that a virtual character makes different attitudes as time changes. These attitudes appear to be continuous as time changes. Usually with a specific time interval as a frame, multi-frame sequence data for describing positions and rotation of the character's key skeleton nodes is used as attitude data. Character motion animation refers to the animation that the attitude change of the virtual character matches a position trajectory when its position changes, which makes the virtual character and a real person or object behave similarly in action when the position moves due to the interaction between the virtual character and the environment.

Network synchronization: A plurality of devices enter the same virtual scene through communication technologies such as the Internet. Characters controlled by different devices perform various actions on a current device. Through network communication, the characters displayed on other devices also perform the same actions. Network synchronization refers to a technology and a process that enable actual objects representing the same character on different devices to perform the same actions in real time through network communication.

Main control terminal and simulation terminal: In games or virtual reality applications, a plurality of devices (or programs) enter the same scene. Actions such as movement of a virtual character are determined by one of the devices, and consistent actions are performed on other devices and the device that determines the actions of the virtual character through network synchronization presentation. The device that determines the actions of the virtual character is defined as the main control terminal of the virtual character, and the other devices are defined as simulation terminals of the virtual character.

In an embodiment of this disclosure, a synchronous character display method is provided, to more fully use a characteristic that a first character and a second character have the same action cycle, and make transition between action screens of the first character smoother. The synchronous character display method obtained through training in this disclosure includes at least one of a game character synchronization scenario, a modeling character synchronization scenario, and a video conference synchronization scenario when applied. The above application scenarios are only illustrative examples. The synchronous character display method provided in this embodiment can also be applied in other scenarios. This is not limited in this embodiment of this disclosure.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

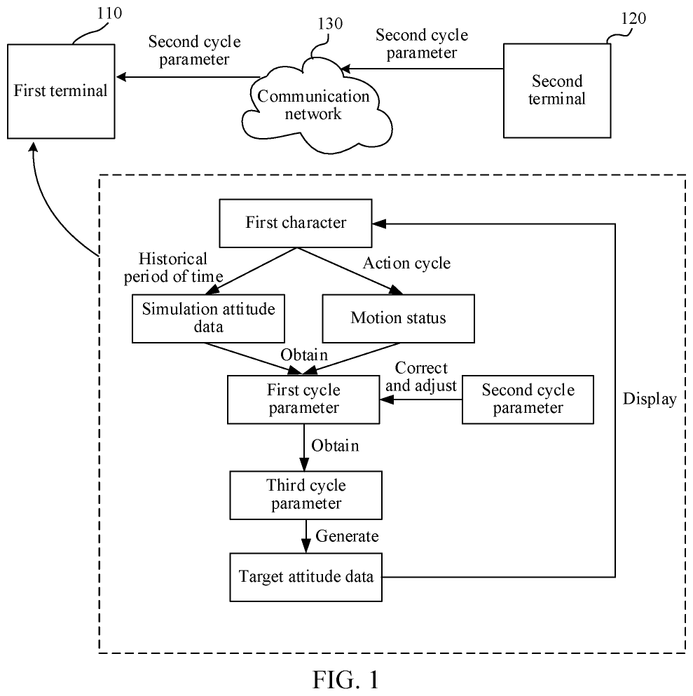

Then, an implementation environment involved in the embodiments of this disclosure is described. For example, referring to FIG. 1, the implementation environment involves a first terminal 110 and a second terminal 120. The first terminal 110 is connected to the second terminal 120 through a communication network 130.

In some embodiments, the first terminal 110 synchronizes a second character displayed on the second terminal 120, and a first character obtained through synchronization is displayed on the first terminal 110.

For example, the first terminal 110 obtains simulation attitude data of a first character in a historical period of time, the first character being a character that is displayed in a first terminal in synchronization with a second character mainly controlled by a second terminal; and obtains, based on the simulation attitude data and a motion status of the first character in a standard action cycle of a current action, a first cycle parameter of the first character at a termination moment of the historical period of time. The first cycle parameter is configured for indicating a state feature corresponding to an action presentation of the first character at the termination moment in the standard action cycle.

In some embodiments, the second terminal 120 is configured to send a second cycle parameter to the first terminal 110. For example, the second terminal 120 can obtain the second cycle parameter through the above parameter obtaining method, the second cycle parameter being configured for indicating a state feature corresponding to an action presentation of the second character at the termination moment in the standard action cycle. For example, the second terminal 120 obtains main control attitude data of a second character in a historical period of time, the second character being a character mainly controlled by the second terminal; and obtains, based on the main control attitude data and a motion status of the second character in a standard action cycle, a second cycle parameter of the second character at a termination moment of the historical period of time.

In one embodiment, after obtaining the second cycle parameter, the second terminal 120 sends the second cycle parameter to the first terminal 110, so that the first terminal 110 adjusts the first cycle parameter based on the second cycle parameter. For example, the first terminal 110 receives the second cycle parameter of the second character at the termination moment sent by the second terminal 120, and corrects and adjusts the first cycle parameter based on the second cycle parameter to obtain an adjusted third cycle parameter.

In one embodiment, the first terminal 110 generates, based on the third cycle parameter, updated attitude data corresponding to the termination moment, and displays, based on the updated attitude data, the first character corresponding to the second character.

The synchronous character display method provided in this embodiment of this disclosure can be implemented through interaction between the first terminal 110 and the second terminal 120, or through interaction between the first terminal 110 and a server, or through interaction between the second terminal 120 and a server, or the like. This is not limited in this embodiment of this disclosure.

The above-mentioned terminals include but are not limited to mobile phones, tablets, portable laptops, wearable devices, intelligent voice interaction devices, smart home appliances, vehicle-mounted terminals and other mobile terminals, or may be implemented as desktop computers, augmented reality (AR) devices, virtual reality (VR) devices, or the like. The server may be an independent physical server, or may be a server cluster or a distributed system formed by a plurality of physical servers, or may be a cloud server that provides basic cloud computing services such as a cloud service, a cloud database, cloud computing, a cloud function, cloud storage, a network service, cloud communication, a middleware service, a domain name service, a security service, a content delivery network (CDN), big data, and an AI platform.

The cloud technology is a hosting technology that unifies a series of resources such as hardware, applications, and networks in a wide area network or a local area network to implement computing, storage, processing, and sharing of data. The cloud technology is a collective name of a network technology, an information technology, an integration technology, a management platform technology, an application technology, and the like based on an application of a cloud computing service mode, and may form a resource pool, which is used as required, and is flexible and convenient.

In some embodiments, the foregoing server may alternatively be implemented as a node in a blockchain system.

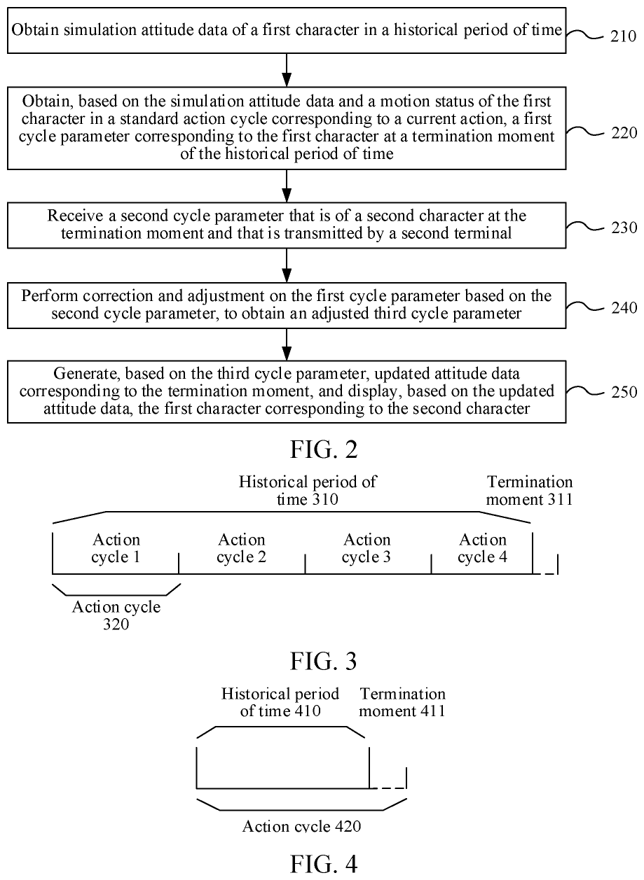

With reference to the above term introduction and application scenarios, the synchronous character display method provided in this disclosure is described. An example in which this method is applied to a terminal is used. As shown in FIG. 2, the method includes the following operations 210 to 250.

Operation 210: Obtain simulation attitude data of a first character in a historical period of time. For example, motion data of a first character over a time period is obtained.

The first character is a character that is displayed in a first terminal in synchronization with a second character mainly controlled by a second terminal. In one embodiment, the first character and the second character are the same character. Interface presentation of this character is mainly controlled and determined by the second terminal. The first terminal synchronizes the interface presentation of the character on the second terminal. The first character is a character displayed on the first terminal. The second character is a character displayed on the second terminal.

In one embodiment, the first character is displayed on the screen corresponding to the first terminal, and the second character is displayed on the screen corresponding to the second terminal. When the first terminal displays the first character, the second character is displayed synchronously according to the received attributes of the second character such as a motion speed and a moving direction, so that the first character is displayed on the first terminal.

For example, the above character can be implemented as a virtual person character or virtual animal character, or can be implemented as a real person character or real animal character, for example, a real person character A as the second character displayed on the second terminal. When the first terminal displays the first character corresponding to the second character, actions, orientations, and other attitudes of the first character are adjusted based on actions, orientations, and other attitudes of the second character, to enable the first terminal to synchronously display the second character displayed on the second terminal.

In one embodiment, virtual person characters include virtual objects in games, modeled persons in project planning, virtual idols in film and television works, and the like; virtual animal characters include virtual pets in games, modeled animals (for example, robot dogs) in robot planning, virtual animals in film and television works, and the like; real person characters include performers in film and television works, conference participants in video conferences, participants in performance activities, athletes in sports event broadcasts, and the like; real animal characters include various animal characters, for example, cats, dogs, snakes, fishes, and birds.

For example, the animation video of the modeled person M (second character) is being played on the second terminal, and the first terminal is a terminal that displays the character synchronously on the second terminal. That is, the modeled person M is displayed synchronously on the first terminal, and the modeled person M displayed synchronously on the first terminal is called the first character. The first character displayed on the first terminal and the second character displayed on the second terminal are synchronized as much as possible.

The historical period of time is configured for indicating a time range covered by a past period of time. For example, the historical period of time is a period of time of the past two seconds, that is, the period of time covered from two seconds ago to the current moment is the historical period of time; or the historical period of time is a period of time of the past five video frames, that is, the period of time covered from the previous five video frames to the current video frame is the historical period of time.

In one embodiment, the historical period of time is a client time. For example, the first terminal obtains the simulation attitude data of the first character in the client's past two seconds of running time. For example, the first terminal obtains the simulation attitude data of the first character in the client's past displayed 50 video frames.

In one embodiment, duration of the historical period of time is preset duration. In one embodiment, the number of video frames covered by the historical period of time is a preset video frame number.

In an embodiment, the first character is implemented as a real person character/real animal character, and the real person character/real animal character is equipped with at least one data obtaining component for monitoring simulation attitude data; simulation attitude data of a first character in a historical period of time is obtained through the data obtaining component.

For example, the first character is implemented as a real person character, the four limbs of the first character are equipped with data obtaining components, the simulation, attitude data of the first character in the historical period of time is determined through the data obtained by the data obtaining components respectively corresponding to the four limbs; or the first character is implemented as a real person character, the body of the first character is equipped with fluorescent clothing, the simulation, attitude data of the first character in the historical period of time is determined based on the motion status of the first character displayed by the fluorescent clothing.

The simulation attitude data is configured for indicating the attitude data generated during the motion of the first character.

In one embodiment, the attitude data includes at least one of the following forms.

### (1) Skeleton Key Point Position Data

For example, at least one skeleton key point is determined on the first character, and during the motion of the first character, the position change status of the first character is determined through the position change status of the at least one skeleton key point in the animation. The position change status of the at least one skeleton key point in the animation is used as the above-mentioned skeleton key point position data. Through the skeleton key point position data, the action status of the first character in the animation can be roughly determined. For example, if there is a curve change in the distribution of the skeleton key point position data, the first character performs running motion during the historical period of time; or if there is no change in the distribution of the skeleton key point position data, the first character is in a stationary state during the historical period of time.

### (2) Motion Speed Data

For example, the motion speed data is configured for indicating the motion speed of the first character in the animation during the historical period of time. For example, the first character is implemented as a real person character, and the real person character runs at a constant speed of 3 m/s during the historical period of time; or the first character is implemented as a fish, and the fish's tail fin rotates at a speed of 30°/s during the historical period of time.

### (3) Motion Direction Data

For example, the motion direction data is configured for indicating the motion direction of the first character in the animation during the historical period of time. For example, the first character is implemented as a real person character, and the real person character moves forward during the historical period of time.

### (4) Motion Trajectory Data

For example, the motion trajectory data is configured for indicating the motion trajectory of the first character in the animation during the historical period of time. For example, the first character is implemented as a real person character. The real person character moves forward within the historical period of time, and then moves forward diagonally, and the motion trajectory is implemented as a polyline segment a; or the first character is implemented as a snake. The snake performs irregular curved motion forward within the historical period of time, and the motion trajectory is implemented as a curve segment c.

### (5) Motion Type Data

For example, the motion type data is configured for indicating the motion form of the first character within the historical period of time, where the motion form is related to the character type of the first character. For example, the first character is implemented as a real person character (that is, the character type of the first character is a real person), the real person character performs bipedal running motion in a historical period of time, and the bipedal running motion is used as the motion type data of the first character; or the first character is implemented as a snake (that is, the character type of the first character is a snake), the snake performs standing motion in a historical period of time, and the standing motion is used as the motion type data of the first character.

The above examples are only illustrative. This is not limited in this embodiment of this disclosure.

For example, the first character is implemented as a real person character T. During the historical period of time, the real person character T performs bipedal running motion in a picture. When the simulation attitude data is obtained, attitude data generated when the real person character T performs bipedal running motion in the historical period of time is obtained. For example, at least one of various types of simulation attitude data such as skeleton key point position data, motion speed data, motion direction data, motion trajectory data, and motion type data that are generated when the real person character T performs bipedal running motion in the historical period of time is obtained.

Operation 220: Obtain, based on the simulation attitude data and a motion status of the first character in a standard action cycle corresponding to a current action, a first cycle parameter corresponding to the first character at a termination moment of the historical period of time. For example, a first phase parameter for the first character at an end of the time period is determined based on the motion data and a standard action cycle for a current action that is performed by the first character.

In one embodiment, the standard action cycle is configured for indicating a standard period of time for the first character to complete the current action, and the current action is the action currently performed by the first character. The current action is the action performed by the first character at the termination moment of the historical period of time. The type of the current action is related to the character type of the first character.

In one embodiment, a first cycle parameter of the first character at a termination moment of the historical period of time is obtained based on the simulation attitude data in combination with a motion status in a standard action cycle of a current action. In one embodiment, the current action is the action that has been performed by the first character in the historical period of time and has not been completed.

For example, when the character type of the first character is a real person, the first character is implemented as a real person character. Since the motion mode of the real person character is usually implemented as bipedal walking, bipedal walking is used as the current action to determine a period of time when the first character completes a bipedal walking action, and this period of time is used as the standard action cycle of the current action. For example, the moment when the left foot is about to be lifted is used as the beginning of a standard action cycle, and the moment when the right foot is dropped back to the ground is used as the end of a standard action cycle.

Alternatively, when the character type of the first character is a fish, the first character is implemented as a fish character. Since the motion mode of the fish is usually implemented as tail fin pushing, tail fin pushing is used as the current action to determine a period of time when the first character completes a tail fin pushing process, and this period of time is used as the standard action cycle of the current action. For example, the moment when the tail fin starts to swing to one side is used as the beginning of a standard action cycle; the moment when the tail fin swings from that side to the starting point is used as half of a standard action cycle (half cycle); the moment when the tail fin swings from the other side to the starting point is used as the end of a standard action cycle.

In an embodiment, the current action is determined based on the simulation attitude data of the first character in the historical period of time. In one embodiment, the current action is determined based on the motion type data in the simulation attitude data.

For example, the first character is implemented as a real person character, and the real person character is the character type of the first character. After the simulation attitude data is obtained, the motion type indicated by the motion type data in the simulation attitude data is used as target motion performed by the first character within the historical period of time.

For example, the motion type data in the simulation attitude data indicates that the first character performs bipedal running motion within the historical period of time, and bipedal running motion is used as the target motion of the first character; or the motion type data in the simulation attitude data indicates that the first character performs bipedal jumping motion within the historical period of time, and bipedal jumping motion is used as the target motion of the first character.

In one embodiment, a standard action cycle corresponding to the current action is determined based on the current action.

For example, the first character is implemented as a real person character, and the motion indicated by the motion type data in the simulation attitude data is bipedal running motion, that is, the current action is bipedal running. When the standard action cycle corresponding to bipedal running (current action) is determined, the period of time in which the first character completes a bipedal running action is used as the standard action cycle. For example, the moment when the left foot is about to be lifted is used as the beginning of a standard action cycle, and the moment when the right foot is dropped back to the ground is used as the end of a standard action cycle.

Alternatively, the first character is implemented as a real person character, and the motion indicated by the motion type data in the simulation attitude data is bipedal jumping motion, that is, the current action is bipedal jumping. When the standard action cycle corresponding to bipedal jumping (current action) is determined, the period of time in which the first character completes a bipedal jumping action is used as the standard action cycle. For example, the moment when the knees start to bend is used as the beginning of a standard action cycle, the moment when soaring starts is used as half of a standard action cycle (half cycle), and the moment when the knees are straightened is used as the end of a standard action cycle.

Alternatively, the character type of the first character is a fish, and the motion indicated by the motion type data in the simulation attitude data is tail fin pushing, that is, the current action is tail fin pushing. When the standard action cycle corresponding to tail fin pushing (current action) is determined, the moment when the tail fin starts to swing to one side is used as the beginning of a standard action cycle; the moment when the tail fin swings from that side to the starting point is used as half of a standard action cycle (half cycle); the moment when the tail fin swings from the other side to the starting point is used as the end of a standard action cycle.

The above examples are only illustrative. This is not limited in this embodiment of this disclosure.

In an embodiment, a first cycle parameter is obtained based on the simulation attitude data and a motion status of the first character in a standard action cycle.

The first cycle parameter is configured for indicating a state feature corresponding to an action presentation of the first character at the termination moment in the standard action cycle. The state feature indicates a state corresponding to an action presentation of the first character at the termination moment in the standard action cycle. For example, if the action of the first character at the termination moment is “step the right leg forward”, and the standard action cycle includes “step the left leg forward (phase is 0)—drop the left leg to the ground (phase is π/2)—step the right leg forward (phase is π)—drop the right leg to the ground (phase is 2π)”, the state feature is determined to be π.

In one embodiment, after the termination moment corresponding to the historical period of time is determined, the standard action cycle corresponding to the action presentation at the termination moment is determined. For example, as shown in FIG. 3, FIG. 3 is a schematic diagram of determining a standard action cycle. A historical period of time 310 is determined through a start moment and a termination moment 311. The historical period of time 310 includes a plurality of action cycles 320, for example, an action cycle 1, an action cycle 2, and an action cycle 3, and the historical period of time 310 includes a partial period of time of an action cycle 4, where the termination moment 311 is located within the action cycle 4, the action cycle 4 where the termination moment 311 is located is used as a standard action cycle corresponding to an action presentation at the termination moment.

Alternatively, as shown in FIG. 4, FIG. 4 is another schematic diagram of determining a standard action cycle. A historical period of time 410 is determined through a start moment and a termination moment 411. The historical period of time 410 is located within an action cycle 420, that is, the termination moment 411 is located within the action cycle, the action cycle where the termination moment 411 is located is used as a standard action cycle corresponding to an action presentation at the termination moment.

For example, a first cycle parameter is obtained based on the simulation attitude data and a motion status of the first character in a standard action cycle corresponding to the termination moment.

For example, skeleton key point position data of the first character in the simulation attitude data, and skeleton key point position reference data of the first character in the standard action cycle corresponding to the termination moment are obtained, and the skeleton key point position data is compared with the skeleton key point position reference data, to determine the first cycle parameter.

For example, after the skeleton key point position data is compared with the skeleton key point position reference data, the skeleton key point position reference data corresponding to the skeleton key point position data is determined, and the first cycle parameter is determined based on the skeleton key point position reference data at the termination moment.

The first cycle parameter is configured for indicating a state feature corresponding to an action presentation of the first character at the termination moment in the standard action cycle. The state feature indicates a state corresponding to an action presentation of the first character at the termination moment in the standard action cycle. A cycle parameter can be understood as a phase in a cycle function. For example, a motion cycle of a standard bipedal marching action includes “step the left leg forward (phase is 0)—drop the left leg to the ground (phase is π/2)—step the right leg forward (phase is R)—drop the right leg to the ground (phase is 2π)”. If the first character performs the action of stepping the right leg forward at the termination moment, the first cycle parameter is determined to be π.

The above examples are only illustrative. This is not limited in this embodiment of this disclosure.

Operation 230: Receive a second cycle parameter that corresponds to a second character at the termination moment and that is transmitted by a second terminal. For example, a second phase parameter from the second terminal is received. In an example, the second phase parameter corresponds to the second character at the end of the time period.

The second cycle parameter is configured for indicating a state feature corresponding to an action presentation of the second character at the termination moment in the standard action cycle. The state feature indicates a state corresponding to an action presentation of the second character at the termination moment in the standard action cycle. For example, if the action of the second character at the termination moment is “drop the right leg to the ground”, and the standard action cycle includes “step the left leg forward (phase is 0)—drop the left leg to the ground (phase is π/2)—step the right leg forward (phase is π)—drop the right leg to the ground (phase is 2π)”, the state feature is determined to be 2π.

The termination moment here is the client time on the second terminal, and the termination moment is the time for to-be-executed picture synchronization of the client on the second terminal.

In one embodiment, the second terminal determines the second cycle parameter by using the above method for the first terminal to determine the first cycle parameter. For example, the second terminal obtains the main control attitude data of the second character in the historical period of time, and obtains, based on the main control attitude data and a motion status of the second character in a standard action cycle of the current action, a second cycle parameter of the second character at a termination moment of the historical period of time.

In one embodiment, the second terminal sends the second cycle parameter of the second character at the termination moment to the first terminal, so that the first terminal adjusts the display status of the first character at the termination moment after receiving the second cycle parameter.

The second cycle parameter is configured for indicating the state of the action performed by the second character at the termination moment in the motion cycle. A cycle parameter can be understood as a phase in a cycle function. For example, a motion cycle of a standard bipedal marching action includes “step the left leg forward (phase is 0)—drop the left leg to the ground (phase is π/2)—step the right leg forward (phase is R)—drop the right leg to the ground (phase is 2π)”. If the second character performs the action of dropping the right leg to the ground at the termination moment, the second cycle parameter is determined to be 2π.

Operation 240: Perform correction and adjustment on the first cycle parameter based on the second cycle parameter, to obtain an adjusted third cycle parameter. For example, the first phase parameter is adjusted based on the second phase parameter to obtain a third phase parameter.

The third cycle parameter is configured for indicating an adjusted state feature corresponding to an action presentation of the first character at the termination moment in the standard action cycle. The state feature indicates an adjusted state corresponding to an action presentation of the first character at the termination moment in the standard action cycle. For example, if the adjusted action of the first character at the termination moment is “drop the right leg to the ground”, and the standard action cycle includes “step the left leg forward (phase is 0)—drop the left leg to the ground (phase is π/2)—step the right leg forward (phase is π)—drop the right leg to the ground (phase is 2π)”, the state feature is determined to be 2π.

For example, after obtaining the second cycle parameter sent by the second terminal, the second cycle parameter is compared with the first cycle parameter, and the first cycle parameter is adjusted based on the comparison result, so that the first character displayed by the first terminal can have greater synchronization with the second character displayed by the second terminal.

In an embodiment, in response to a difference between parameter values of the second cycle parameter and the first cycle parameter, correction and adjustment are performed on the first cycle parameter, to obtain an adjusted third cycle parameter.

In one embodiment, in response to a difference between a parameter value of the second cycle parameter and a parameter value of the first cycle parameter, a parameter value change rate of the first cycle parameter is adjusted, and correction and adjustment are performed on the first cycle parameter based on the parameter value change rate, to obtain an adjusted third cycle parameter.

For example, in response to a case that a parameter value of the second cycle parameter is greater than a parameter value of the first cycle parameter, a parameter value change rate of the first cycle parameter is increased, and correction and adjustment are performed on the first cycle parameter based on the increased parameter value change rate, to obtain an adjusted third cycle parameter.

Alternatively, in response to a case that a parameter value of the second cycle parameter is less than a parameter value of the first cycle parameter, a parameter value change rate of the first cycle parameter is reduced, and correction and adjustment are performed on the first cycle parameter based on the reduced parameter value change rate, to obtain an adjusted third cycle parameter.

In an embodiment, in response to the comparison result indicating that the second cycle parameter is the same as the first cycle parameter, the second cycle parameter is used as the third cycle parameter; or the first cycle parameter is used as the third cycle parameter.

The above examples are only illustrative. This is not limited in this embodiment of this disclosure.

Operation 250: Generate, based on the third cycle parameter, updated attitude data corresponding to the termination moment, and display, based on the updated attitude data, the first character corresponding to the second character. For example, updated motion data for the first character is generated based on the third phase parameter. The first character is displayed based on the updated motion data.

The updated attitude data refers to the attitude data obtained by updating the attitude data corresponding to the termination moment in the historical period of time.

For example, after obtaining the adjusted third cycle parameter, the attitude data of the first character is adjusted through the third cycle parameter, and updated attitude data corresponding to the termination moment is generated.

In an embodiment, while adjusting the first cycle parameter, the display process of the first character continues. In this process, the first cycle parameter is quickly adjusted based on the second cycle parameter, to obtain a third cycle parameter that changes rapidly with the display process. Based on the rapidly changing third cycle parameter, updated attitude data corresponding to the display moment is quickly generated.

In one embodiment, the first terminal determines the display mode of the first character through the generated updated attitude data, thereby displaying the first character corresponding to the second character on the screen corresponding to the first terminal. For example, the action of the first character displayed on the first terminal is synchronized with the action of the second character displayed on the second terminal.

In an embodiment, updated attitude data is generated based on the third cycle parameter combined with the motion status of the first character within the standard action cycle of the current action; and a synchronization action of the first character corresponding to a second character is displayed according to the updated attitude data.

To sum up, Simulation attitude data of a first character in a historical period of time is obtained, and a first cycle parameter of the first character at a termination moment of the historical period of time is obtained in combination with a motion status of the first character in a standard action cycle of a current action; correction and adjustment are performed on the first cycle parameter based on a second cycle parameter transmitted by a second terminal, to obtain a third cycle parameter; updated attitude data is generated based on the third cycle parameter; and the first character corresponding to a second character is displayed according to the updated attitude data.

Through the foregoing method, the motion status of the first character in the standard action cycle of the current action can be considered, and the characteristic that the first character and the second character have the same action cycle can be fully used. The first cycle parameter is adjusted on the first terminal based on the second cycle parameter, to make transition between action screens of the first character smoother.

In addition, the second terminal transmits the second cycle parameter to the first terminal, and the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

In an embodiment, the first cycle parameter is obtained using a parameter assignment method. For example, as shown in FIG. 5, operation 220 in the embodiment shown in FIG. 2 can also be implemented as the following operations 510 to 530.

Operation 510: Obtain a cycle motion status of the first character in the standard action cycle corresponding to the current action. For example, cycle motion data for the first character is obtained in the standard action cycle.

In one embodiment, the standard action cycle is configured for indicating a standard period of time for the first character to complete the current action, and the current action is related to the character type of the first character. The current action is determined based on the action status of the first character in the screen. The cycle motion status is configured for indicating an action execution status of the first character in a process of completing the current action.

For example, when the character type of the first character is a real person, the first character is implemented as a real person character. Since the motion mode of the real person character is usually implemented as bipedal walking, bipedal walking is used as the current action to determine a period of time when the first character completes a bipedal walking action, and this period of time is used as the standard action cycle of the current action. For example, the moment when the left foot is about to be lifted is used as the beginning of a standard action cycle, and the moment when the right foot is dropped back to the ground is used as the end of a standard action cycle.

In one embodiment, after determining the standard action cycle corresponding to the current action, the motion status of the first character within the standard action cycle is used as the cycle motion status. For example, a series of motion statuses including lifting the left foot-raising the left leg to the highest point-dropping the left leg-lifting the right leg-raising the right leg to the highest point-dropping the right leg are used as the cycle motion status corresponding to the standard action cycle.

Operation 520: Perform, based on the simulation attitude data and the cycle motion status, parameter assignment on video frames of the first character in the historical period of time. For example, parameter values to video frames of the first character in the time period are assigned based on the motion data and the cycle motion data.

For example, after obtaining the simulation attitude data and the cycle motion status, parameter assignment is performed on video frames in the historical period of time, that is, for the video frames in the historical period of time, at least one video frame is assigned a corresponding cycle parameter. The video frames include a termination video frame corresponding to the termination moment of the historical period of time, that is, parameter assignment is performed on the termination video frame corresponding to the termination moment of the historical period of time to determine the first cycle parameter corresponding to the termination video frame.

In an embodiment, key point position data corresponding to a video frame in the simulation attitude data is obtained.

The key point position data is configured for indicating a position change status of a corresponding key point of the first character in different video frames.

In one embodiment, the simulation attitude data includes key point position data. Through the key point position data, the motion status of the first character in a series of video frames can be roughly learned.

For example, at least one key point is determined on the first character in the form of pre-marking. For example, the first character is a real person character A. Five key points on the real person character A are determined in the form of pre-marking and are respectively located at the center of the head and the centers of the four limbs. According to the motion status of the first character in the historical period of time, the position change statuses corresponding to the five key points in a plurality of continuously changing video frames are determined, and the key point position data corresponding to the first character is obtained based on the position change statuses corresponding to the five key points.

In an embodiment, reference key point position data in the standard action cycle is determined based on the cycle motion status of the first character in the standard action cycle.

For example, based on the cycle motion status of the first character within the standard action cycle, the key point position data corresponding to different cycle moments within the standard action cycle is used as the reference key point position data.

In one embodiment, when the first character is implemented as a real person character and the current action is implemented as a bipedal running action, taking the analysis of foot motion as an example, a preset key point is located on a foot, the moment when the left foot starts to be lifted is used as the start moment of the standard action cycle, the left foot is raised to the highest point and then the left foot is lowered, the right foot is raised to the highest point and then the right foot is lowered, and the moment when the right foot is dropped to the ground is used as the end moment of the standard action cycle. There is a plurality of cycle moments within this standard action cycle, and the key point position data corresponding to different cycle moments are different.

For example, at the start moment of the standard action cycle, the left foot is in a state of starting to be lifted, and position data of a key point located on the foot begins to change relative to the stationary state, and the position data of the key point is used as reference key point position data corresponding to the start moment. For example, one/more pieces of key point position data corresponding to the left foot are used use as the reference key point position data corresponding to the start moment; or one/more pieces of key point position data corresponding to the left foot and one/more pieces of key point position data corresponding to the right foot are used use as the reference key point position data corresponding to the start moment.

Similarly, at an intermediate moment in the standard action cycle, the left foot is in a soaring state, and the key point position data corresponding to the foot at this moment is used as the reference key point position data at the intermediate moment. For example, one/more pieces of key point position data corresponding to the left foot are used use as the reference key point position data corresponding to the intermediate moment; or one/more pieces of key point position data corresponding to the left foot and one/more pieces of key point position data corresponding to the right foot are used use as the reference key point position data corresponding to the intermediate moment.

Similarly, at a termination moment in the standard action cycle, the right foot is dropped back to the ground, and the key point position data corresponding to the foot at this moment is used as the reference key point position data at the termination moment. For example, one/more pieces of key point position data corresponding to the right foot are used use as the reference key point position data corresponding to the start moment; or one/more pieces of key point position data corresponding to the left foot and one/more pieces of key point position data corresponding to the right foot are used use as the reference key point position data corresponding to the start moment.

A plurality of moments within the standard action cycle such as the start moment, an intermediate moment, and the termination moment are different cycle moments within the standard action cycle. When determining the reference key point position data, based on the cycle motion statuses of the first character at different cycle moments, the key point position data of the first character at the corresponding cycle moments is used as the reference key point position data. To be specific, reference key point position data corresponding to a plurality of cycle moments in the standard action cycle is determined based on the cycle motion status of the first character in the standard action cycle.

In one embodiment, a corresponding cycle moment is expressed in the form of a video frame, that is, when determining a cycle moment, a plurality of video frames within the standard action cycle are determined, and corresponding action states are presented under different video frames. Based on key point position data displayed in the action states, the reference key point position data corresponding to different video frames is determined.

In an embodiment, parameter assignment is performed on the reference key point position data, and a parameter assignment result corresponding to the reference key point position data is determined.

For example, parameter assignment is configured for indicating that different reference key points are assigned corresponding parameter values, so that different reference key point position data has corresponding parameter values.

In one embodiment, when parameter assignment is performed on the reference key point position data, parameter assignment is performed on the reference key point position data corresponding to at least two preset special cycle moments. The preset special cycle moment is configured for indicating the preset cycle moment used when determining the standard action cycle.

For example, when determining the standard action cycle in which a real person character performs bipedal running, a cycle start moment and a cycle termination moment corresponding to the bipedal running are preset, and the cycle start moment and the cycle termination moment are used as the above preset special cycle moments; or when determining the standard action cycle in which a fish performs tail fin swinging, a cycle start moment, a half cycle moment, and a cycle termination moment corresponding to the tail fin swinging are preset, and the cycle start moment, the half cycle moment, and the cycle termination moment are used as the above preset special cycle moments.

In an embodiment, description is made by using an example in which the preset special cycle moments are implemented as the cycle start moment and the cycle termination moment. The process of performing parameter assignment on the preset special cycle moments is as follows.

In one embodiment, a cycle start moment and a cycle termination moment in the standard action cycle are determined.

For example, based on the difference in character type and current action, the cycle start moment and the cycle termination moment corresponding to the standard action cycle are determined.

For example, the character type is implemented as a real person, and the current action is implemented as bipedal running. When determining the corresponding standard action cycle, based on the action execution status of the real person character during bipedal running, the cycle start moment of the standard action cycle of bipedal running is determined as the moment when the left foot starts to be lifted; and the cycle termination moment of the standard action cycle of bipedal running is determined as the moment when the right foot is dropped back to the ground.

Alternatively, the character type is implemented as a fish, and the current action is implemented as tail fin swinging. When determining the corresponding standard action cycle, based on the action execution status of the fish during tail fin swinging, the cycle start moment of the standard action cycle of the fish is determined as the moment when the tail fin begins to swing to one side; and the cycle termination moment of the standard action cycle of the fish is determined as the moment when the tail fin swings from the other side to the initial position.

Alternatively, the character type is implemented as a bird, and the current action is implemented as wing flapping. When determining the corresponding standard action cycle, based on the action execution status of the bird during wing flapping, the cycle start moment of the standard action cycle of the bird is determined as the moment when the wings start to flap from the front side; and the cycle termination moment of the standard action cycle of the fish is determined as the moment when the wings swing from the rear side to the initial position.

The process of determining the cycle start moments of the standard action cycle such as the moment when the left foot begins to be lifted, the moment when the tail fin begins to swing to one side, and the moment when the wings begin to flap from the front side; and the cycle termination moments of the standard action cycle such as the moment when the right foot is dropped back to the ground, the moment when the tail fin swings from the other side to the initial position, and the moment when the wings swing from the rear side to the initial position is only a schematic example. The cycle start moment and the cycle termination moment can be set in other setting forms. This is not limited in this embodiment of this disclosure.

In an embodiment, parameter assignment is performed on reference key point position data corresponding to the cycle start moment, to obtain a start parameter corresponding to the cycle start moment; and parameter assignment is performed on reference key point position data corresponding to the cycle termination moment, to obtain a termination parameter corresponding to the cycle termination moment.

In one embodiment, the parameter assignment process is implemented in a customized way. For example, after determining the cycle start moment and the cycle termination moment of the standard action cycle, parameter assignment is performed on the reference key point position data corresponding to the cycle start moment and the cycle termination moment, thereby obtaining a start parameter corresponding to the cycle start moment and a termination parameter corresponding to the cycle termination moment.

In one embodiment, considering that the standard action cycle is a period of time determined by a time series, when parameter assignment is performed on the cycle start moment and the cycle termination moment corresponding to the standard action cycle, the parameter assignment process is performed in ascending order of parameters.

For example, a customized parameter assignment manner is used, where if the reference key point position data corresponding to the start moment of the cycle is assigned 0, the start parameter is 0; and if the reference key point position data corresponding to the termination moment of the cycle is assigned 1, the termination parameter is 1.

Alternatively, if the reference key point position data corresponding to the start moment of the cycle is assigned 0, the start parameter is 0; and if the reference key point position data corresponding to the termination moment of the cycle is assigned 2pi, the termination parameter is 2pi.

In an embodiment, at least one cycle moment between the cycle start moment and the cycle termination moment, and reference key point position data corresponding to the at least one cycle moment are obtained.

For example, after obtaining at least one cycle moment between the cycle start moment and the cycle termination moment, reference key point position data corresponding to the cycle moment is determined, that is, based on the preset key point position status corresponding to the first character, the reference key point position data of the first character at this cycle moment is determined.

In an embodiment, parameter assignment is performed on the reference key point position data corresponding to the at least one cycle moment through an interpolation method, and a parameter assignment result corresponding to the reference key point position data is determined.

For example, the cycle moment in the standard action cycle other than the cycle start moment and the cycle termination moment is used as the above-mentioned at least one cycle moment. The parameter assignment result corresponding to the at least one cycle moment is determined within the standard action cycle through the interpolation method.

In one embodiment, the basic principle of the above-mentioned interpolation method, also known as “interpolating method” is to use function values of a function f(x) at several known points in a certain interval to determine an appropriate particular function, and use values of the particular function at other points in the interval as approximate values of the function f(x) at the other points.

The interpolation method is configured for obtaining a continuous function curve by performing fitting according to function values of limited discrete data. Function values of other discrete data can be obtained through the continuous function curve. In this embodiment, the interpolation method is configured for constructing a continuous cycle parameter function curve based on the cycle parameter at the cycle start moment and the cycle parameter at the cycle termination moment within the known standard action cycle. The cycle parameter corresponding to any moment in the standard action cycle can be obtained through the continuous cycle parameter curve.

In one embodiment, the interpolation method (that is, the method for constructing a continuous function curve) can include any one or a combination of many interpolation algorithms such as the method of inverse distance to a power, the Kriging method, the minimum curvature method, the polynomial regression method, the radial basis function method, the linear interpolation method, and the natural neighbor interpolation method, and the nearest neighbor interpolation method. This is not limited in this embodiment of this disclosure.

For example, the interpolation method is configured for performing parameter assignment on the reference key point position data corresponding to at least one cycle moment according to the known cycle parameter within the standard action cycle, thereby obtaining the parameter assignment result corresponding to the reference key point position data.

In one embodiment, a first cycle interval between a designated cycle moment of the at least one cycle moment and the cycle start moment, and a second cycle interval between the designated cycle moment and the cycle termination moment are determined.

For example, the designated cycle moment is configured for indicating any moment in the at least one cycle moment. Description is made by using an example in which the parameter assignment result corresponding to the designated cycle moment is determined.

For example, if the designated cycle moment is the (¼)^{th} cycle moment in the standard action cycle, the first cycle interval between the designated cycle moment and the cycle start moment is determined to be ¼; and similarly, the second cycle interval between the designated cycle moment and the cycle termination moment is determined to be ¾ (1−¼).

In one embodiment, the parameter assignment result corresponding to the designated moment is determined based on the first cycle interval, the second cycle interval, the start parameter, and the termination parameter through the interpolation method.

For example, Description is made by using an example in which the start parameter corresponding to the cycle start moment is assigned a value of 0, and the termination parameter corresponding to the cycle termination moment is assigned a value of 2pi. After determining that the first cycle interval is ¼, the second cycle interval is ¾, the start parameter is 0, and the termination parameter is 2pi, based on the designated cycle moment being between the cycle start moment and the cycle termination moment, the parameter assignment result corresponding to the designated cycle moment is determined through the interpolation method. Table 1 is an interpolation table between cycle moments and parameter assignment results.

TABLE 1

| | 0 (cycle start | ¼ (designated | 1 (cycle termination |
|---|---|---|---|
| Cycle moment | moment) | cycle moment) | moment) |
| Parameter | 0 | x | 2pi |
| assignment result | | | |

A parameter assignment result corresponding to a designated cycle moment is set to x, the parameter assignment result x is a cycle parameter at the designated cycle moment, the parameter assignment result x is related to a start parameter and a termination parameter, and the parameter assignment result x is determined through the following interpolation formula.

$$x = \frac{( 2 p i - 0 )}{( 1 - 0 )} \times ( 1 / 4 - 0 ) + 0 = 1 / 4 pi$$

To be specific, based on the cycle start moment and the cycle termination moment, the cycle parameter at the (¼)^{th} cycle moment is determined to be ¼pi through the interpolation method, that is, the parameter assignment result corresponding to the designated cycle moment is ¼pi.

In an embodiment, after determining the parameter assignment result corresponding to the designated cycle moment in the standard action cycle based on the first cycle interval, the second cycle interval, the start parameter, and the termination parameter, when parameter assignment results corresponding to other designated cycle moments in the standard action cycle are determined, a cycle range of the other designated cycle moments within the standard action cycle is determined, and the parameter assignment results corresponding to the other designated cycle moments are determined based on the cycle range.

For example, the cycle range is configured for indicating the minimum surrounding range of the other designated cycle moments within the standard action cycle. For example, there is a corresponding parameter assignment result at the start point of the cycle range; and there is a corresponding parameter assignment result at the termination point of the cycle range. The other designated cycle moments are located within this cycle range, and there are no other cycle moments with a corresponding parameter assignment range.

For example, the parameter assignment results corresponding to different designated cycle moments are determined using the following interpolation formula.

$${P}_{3} = \frac{( {P}_{2} - {P}_{1} )}{( {T}_{2} - {T}_{1} )} \times ( {T}_{3} - 0 ) + {P}_{1}$$

P₃ is configured for indicating the parameter assignment result to be determined; T₃ is configured for indicating the cycle moment at which the parameter assignment result is be determined; T₂ is configured for indicating the most recent cycle moment that is later than T₃ in the standard action cycle of the time series and that has a parameter assignment result; T₁ is configured for indicating the most recent cycle moment that is earlier than T₃ in the standard action cycle of the time series and that has a parameter assignment result; P₂ is configured for indicating the parameter assignment result corresponding to T₂; P₁ is configured for indicating the parameter assignment result corresponding to T₁.

To be specific, after determining the parameter assignment results corresponding to the designated cycle moment based on the cycle start moment and the cycle termination moment, parameter assignment results corresponding to other cycle moments in the standard action cycle can be determined based on the cycle start moment, the cycle termination moment, and the designated cycle moment using the above interpolation method and interpolation formula, to determine parameter assignment results respectively corresponding to a plurality of cycle moments in the standard action cycle. Different cycle moments have corresponding reference key point position data. Based on the parameter assignment results respectively corresponding to the plurality of cycle moments, parameter assignment results respectively corresponding to a plurality of pieces of reference key point position data are determined.

The above examples are only illustrative. This is not limited in this embodiment of this disclosure.

In an embodiment, the key point position data is compared with the reference key point position data, and parameter assignment is performed on the video frames of the first character in the historical period of time through the parameter assignment result.

For example, after obtaining corresponding key point position data at different cycle moments, the key point position data at the different cycle moments is compared with the reference key point position data. For example, the reference key point position data that is closest to the key point position data is determined, a video frame corresponding to the key point position data is determined, and a parameter assignment result corresponding to the reference key point position data is used as a cycle parameter corresponding to the video frame. Therefore, the process of performing parameter assignment on video frames of the first character in the historical period of time is implemented, and cycle parameters corresponding to the video frames of the first character in the historical period of time are obtained.

Operation 530: Obtain the first cycle parameter of the first character in the termination video frame. For example, the first phase parameter is determined from a parameter value of an end video frame of the video frames in the time period.

For example, after performing parameter assignment on the video frames of the first character in the historical period of time, cycle parameters respectively corresponding to a plurality of video frames in the historical period of time are determined, and the video frame corresponding to the termination moment of the historical period of time is referred to as a termination video frame, a cycle parameter corresponding to the termination video frame is used as a first cycle parameter, and the first cycle parameter is obtained.

In one embodiment, the first cycle parameter of the first character in the termination video frame is obtained; or the termination video frame of the first character, and the first cycle parameter corresponding to the first character in the termination video frame are obtained.

The above examples are only illustrative. This is not limited in this embodiment of this disclosure.

To sum up, by obtaining the first cycle parameter of the first character at the termination moment of the historical period of time, the motion status of the first character in the standard action cycle can be considered, and the characteristic that the first character and the second character have the same standard action cycle can be fully used, so that when the first cycle parameter is adjusted by the first terminal based on the second cycle parameter, transition between action screens of the first character is smoother. In addition, because of the process of determining the second cycle parameter by the second terminal, the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

In this embodiment of this disclosure, the process in which the first cycle parameter is obtained using a parameter assignment method is introduced. The time in which the first character completes a current action is determined as the standard action cycle, and a cycle motion status of the first character in the standard action cycle is obtained; and parameter assignment is performed, based on the simulation attitude data and the cycle motion status, on video frames of the first character in the historical period of time, and then the first cycle parameter of the first character in the termination video frame is obtained. Since the first character is a character obtained by synchronously displaying the second character, the first character and the second character have the same character type, and also correspondingly complete a current action in the same standard action cycle. Based on the same standard action cycle, parameter assignment is performed at different cycle moments within the standard action cycle, and a first cycle parameter corresponding to the termination video frame in the historical period of time is determined based on a parameter assignment result obtained after parameter assignment. Based on the first cycle parameter, an action relationship between the first character and the second character can be established, and the expression manner of video frames can be simplified, to complete the adjustment process of synchronous display of the first character by adjusting the first cycle parameter, realize the process of synchronous display of the first character more smoothly by using the same standard action cycle corresponding to the first character and the second character, improve the efficiency of synchronous display, and improve the user experience.

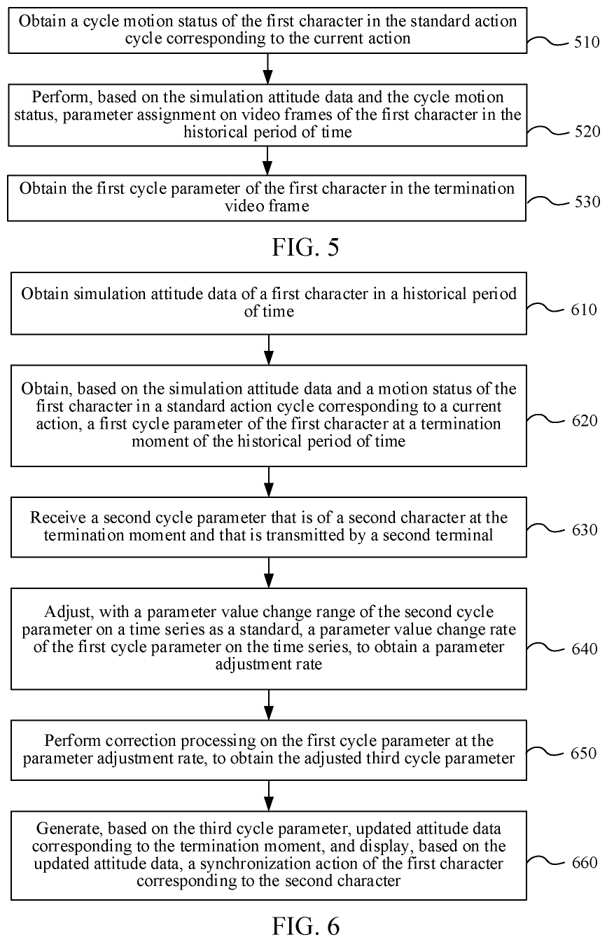

In an embodiment, based on the parameter value change amplitude of the received second cycle parameter in the time series, the first cycle parameter is corrected using a parameter correction method, to obtain the adjusted third cycle parameter. For example, as shown in FIG. 6, the embodiment shown in FIG. 2 can also be implemented as the following operations 610 to 660.

Operation 610: Obtain simulation attitude data of a first character in a historical period of time. For example, motion data of a first character over a time period is obtained.

The first character is a character that is displayed in a first terminal in synchronization with a second character mainly controlled by a second terminal.

Operation 620: Obtain, based on the simulation attitude data and a motion status of the first character in a standard action cycle corresponding to a current action, a first cycle parameter of the first character at a termination moment of the historical period of time. For example, a first phase parameter for the first character at an end of the time period is determined based on the motion data and a standard action cycle for a current action that is performed by the first character.

The first cycle parameter is configured for indicating a state feature corresponding to an action presentation of the first character at the termination moment in the standard action cycle.

Operation 620 has been introduced in the above-mentioned operation 220 and operation 510 to operation 530, and will not be described again here.

Operation 630: Receive a second cycle parameter that is of a second character at the termination moment and that is transmitted by a second terminal. For example, a second phase parameter from the second terminal is received. In an example, the second phase parameter corresponds to the second character at the end of the time period.

The second cycle parameter is configured for indicating a state feature corresponding to an action presentation of the second character at the termination moment in the standard action cycle.

In one embodiment, the second terminal determines the second cycle parameter by using the above method for the first terminal to determine the first cycle parameter. For example, the second terminal obtains the main control attitude data of the second character in the historical period of time, and obtains, based on the main control attitude data and a motion status of the second character in a standard action cycle, a second cycle parameter of the second character at a termination moment of the historical period of time.

In one embodiment, the second terminal sends the second cycle parameter of the second character at the termination moment to the first terminal, so that the first terminal adjusts the display status of the first character at the termination moment after receiving the second cycle parameter.

In an embodiment, a second cycle parameter that is of a second character at a designated moment after the termination moment and that is transmitted by a second terminal is received. The second cycle parameter is configured for indicating a state feature corresponding to the second character at the designated moment in the standard action cycle.

For example, the termination moment is an end moment corresponding to the first historical period of time, and the designated moment is an end moment corresponding to the second historical period of time. The first historical period of time and the second historical period of time are arranged sequentially in the time series.

In one embodiment, the termination moment of the first historical period of time is the start moment of the second historical period of time; or the termination moment of a period of time after the termination moment of the first historical period of time is the start moment of the second historical period of time.

In one embodiment, the time lengths of the first historical period of time and the second historical period of time may be the same or different. For example, using an example in which the time lengths of the first historical period of time and the second historical period of time are the same, the first historical period of time is three video frames, and the second historical period of time is three video frames; or using an example in which the time lengths of the first historical period of time and the second historical period of time are different, the first historical period of time is two seconds, and the second historical period of time is one second.

The above examples are only illustrative. This is not limited in this embodiment of this disclosure.

Operation 640: Adjust, with a parameter value change range of the second cycle parameter on a time series as a standard, a parameter value change rate of the first cycle parameter on the time series, to obtain a parameter adjustment rate. For example, an adjustment rate is determined by adjusting a change rate of the first phase parameter over a temporal sequence based on a parameter value change range of the second phase parameter over the temporal sequence.

For example, after obtaining the second cycle parameter sent by the second terminal, a parameter value change rate of the first cycle parameter corresponding to the first object in the first terminal on the time series is adjusted according to a parameter value change range of the second cycle parameter on the time series.

In an embodiment, when a parameter value change range of the second cycle parameter on a time series is greater than a parameter value change range of the first cycle parameter on the time series, a parameter value change rate of the first cycle parameter on the time series is increased, and an adjusted third cycle parameter is obtained; or when a parameter value change range of the second cycle parameter on a time series is less than a parameter value change range of the first cycle parameter on the time series, a parameter value change rate of the first cycle parameter on the time series is reduced, and an adjusted third cycle parameter is obtained.

In an embodiment, with a parameter value change range of the second cycle parameter on a time series as a standard, a parameter value change rate of the first cycle parameter on the time series is adjusted by adjusting an interpolation calculation speed, to obtain a parameter adjustment rate.

The interpolation calculation speed is configured for indicating a speed at which the first cycle parameter is adjusted to an adjusted first cycle parameter.

In one embodiment, the parameter value change rate of the first cycle parameter on the time series is increased by increasing the interpolation calculation speed; or the parameter value change rate of the first cycle parameter on the time series is reduced by reducing the interpolation calculation speed.

In an embodiment, when a parameter value change range of the second cycle parameter on a time series is greater than a parameter value change range of the first cycle parameter on the time series, a parameter value change rate of the first cycle parameter on the time series is increased, and an adjusted third cycle parameter is obtained; or when a parameter value change range of the second cycle parameter on a time series is less than a parameter value change range of the first cycle parameter on the time series, a parameter value change rate of the first cycle parameter on the time series is reduced, and an adjusted third cycle parameter is obtained.

Operation 650: Perform correction processing on the first cycle parameter at the parameter adjustment rate, to obtain the adjusted third cycle parameter. For example, the adjustment rate is applied to the first phase parameter to obtain the third phase parameter.

For example, after the parameter adjustment rate is determined, the first cycle parameter is corrected at the parameter adjustment rate. For example, when the parameter adjustment rate is high, the first cycle parameter is corrected more quickly, to obtain the third cycle parameter obtained after adjusting the first cycle parameter; or when the parameter adjustment rate is low, the first cycle parameter is corrected more slowly, to obtain the third cycle parameter obtained after adjusting the first cycle parameter.

Operation 660: Generate, based on the third cycle parameter, updated attitude data corresponding to the termination moment, and display, based on the updated attitude data, a synchronization action of the first character corresponding to the second character. For example, updated motion data for the first character is generated based on the third phase parameter. The first character is displayed based on the updated motion data.

For example, after obtaining the adjusted third cycle parameter, the attitude data of the first character is adjusted through the third cycle parameter, and updated attitude data corresponding to the termination moment is generated.

In an embodiment, while adjusting the first cycle parameter, the display process of the first character continues. In this process, the first cycle parameter is quickly adjusted based on the second cycle parameter, to obtain a third cycle parameter that changes rapidly with the display process. Based on the rapidly changing third cycle parameter, updated attitude data corresponding to the display moment is quickly generated.

In one embodiment, the first terminal determines the display mode of the first character through the generated updated attitude data, thereby displaying the first character corresponding to the second character on the screen corresponding to the first terminal. For example, the action of the first character displayed on the first terminal is synchronized with the action of the second character displayed on the second terminal.

The above examples are only illustrative. This is not limited in this embodiment of this disclosure.

To sum up, by obtaining the first cycle parameter of the first character at the termination moment of the historical period of time, the motion status of the first character in the standard action cycle can be considered, and the characteristic that the first character and the second character have the same standard action cycle can be fully used, so that when the first cycle parameter is adjusted by the first terminal based on the second cycle parameter, transition between action screens of the first character is smoother. In addition, because of the process of determining the second cycle parameter by the second terminal, the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

In this embodiment of this disclosure, the process in which the first cycle parameter is corrected using a parameter correction method, to obtain the adjusted third cycle parameter is described. Based on the above parameter determining process, the second terminal obtains the second cycle parameter and sends it to the first terminal. The first terminal corrects and adjusts the first cycle parameter according to the parameter value comparison result of the first cycle parameter and the second cycle parameter. For example, when the first cycle parameter is greater than the second cycle parameter, indicating that the motion of the first character displayed on the first terminal is faster, the action speed of the first character is controlled by controlling the change of the first cycle parameter, and deceleration is performed to wait for the second cycle parameter; or when the first cycle parameter is less than the second cycle parameter, indicating that the motion of the first character displayed on the first terminal is slower, the action speed of the first character is controlled by controlling the change of the first cycle parameter, and acceleration is performed to catch up with the second cycle parameter. The adjusted third cycle parameter is close to the second cycle parameter. To be specific, the first character displayed on the first terminal and the second character displayed on the second terminal present a synchronization effect. With the help of the state features represented by the first cycle parameter and the second cycle parameter, while improving the synchronous display effect, the first character's actions can be adjusted in a timely manner through a faster or slower adjustment method. In addition, by changing the adjustment speed, the parameter value change rate is adjusted, which can better grasp the adjustment intensity, make the animation transition display effect better, and reduce the error rate of synchronous display.

The method for the second terminal to obtain the second cycle parameter in the above operation 620 includes the following:

In an embodiment, the second terminal obtains a cycle motion status of the second character in the standard action cycle corresponding to the current action, the cycle motion status being configured for indicating an action execution status of the second character in a process of completing the current action; performs, based on the main control attitude data and the cycle motion status, parameter assignment on video frames of the second character in the historical period of time, the video frames including a termination video frame corresponding to the termination moment of the historical period of time; and obtains the second cycle parameter of the second character in the termination video frame.

In an embodiment, the second terminal obtains key point position data corresponding to a video frame in the main control attitude data, the key point position data being configured for indicating a position change status of a corresponding key point of the second character; determines, based on the cycle motion status of the second character in the standard action cycle, reference key point position data in the standard action cycle; performs parameter assignment on the reference key point position data, and determining a parameter assignment result corresponding to the reference key point position data; and compares the key point position data with the reference key point position data, and performing parameter assignment on the video frames of the second character in the historical period of time through the parameter assignment result.

In an embodiment, the second terminal determines a cycle start moment and a cycle termination moment in the standard action cycle; performs parameter assignment on reference key point position data corresponding to the cycle start moment, to obtain a start parameter corresponding to the cycle start moment; performs parameter assignment on reference key point position data corresponding to the cycle termination moment, to obtain a termination parameter corresponding to the cycle termination moment; obtains at least one cycle moment between the cycle start moment and the cycle termination moment, and reference key point position data corresponding to the at least one cycle moment; and performs parameter assignment on the reference key point position data corresponding to the at least one cycle moment through an interpolation method, and determines a parameter assignment result corresponding to the reference key point position data.

In an embodiment, the second terminal determines a first cycle interval between a designated cycle moment of the at least one cycle moment and the cycle start moment, and a second cycle interval between the designated cycle moment and the cycle termination moment; and determines, based on the first cycle interval, the second cycle interval, the start parameter, and the termination parameter, the parameter assignment result corresponding to the reference key point position data through the interpolation method.

In an embodiment, the second terminal transmits a parameter value change range of the second cycle parameter on a time series to the first terminal, where the first terminal adjusts, based on the parameter value change range, a parameter value change rate of the first cycle parameter on the time series, to obtain a parameter adjustment rate; and the first terminal performs correction processing on the first cycle parameter at the parameter adjustment rate, to obtain the adjusted third cycle parameter.

The method for the second terminal to obtain the second cycle parameter is similar to the method for the first terminal to obtain the first cycle parameter. Therefore, for details of the second cycle parameter, refer to the above-mentioned introduction to the method for obtaining the first cycle parameter. No further details will be given here.

In an embodiment, the main control terminal instructs the second terminal to display the second character, and the simulation terminal instructs the first terminal to display the first character, that is, the first terminal synchronizes the second character displayed on the second terminal, so that the first character is displayed on the first terminal. The process of performing the synchronous character display method between the main control terminal and the simulation terminal is explained.

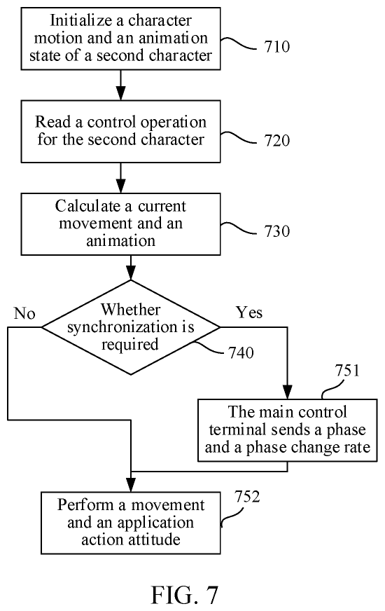

For example, as shown in FIG. 7, the above synchronous character display method can be implemented on the main control terminal as the following operations 710 to 752.

Operation 710: Initialize a character motion and an animation state of a second character.

The main control terminal is configured to instruct the second terminal to display the second character. In a gaming scenario or modeling scene, a plurality of devices (for example, a first terminal and a second terminal) enter the same scene. When a player or program controlling the second terminal controls the second character to perform an action in the screen displayed on the second terminal, the first terminal can synchronously present the action of the second character through a network. To be specific, the first terminal displays the first character corresponding to the second character on the first terminal based on the motion of the second character on the second terminal. The first character is a character obtained by synchronizing the second character, and the above-mentioned device that determines the action of the second character is defined as the main control terminal (second terminal) of the character.

When character synchronization is performed through the above-mentioned synchronous character display method, the main control terminal first initializes the character motion of the second character and initializes the animation state, to avoid interference from irrelevant factors to the character motion and the animation state.

Operation 720: Read a control operation for the second character.

For example, the control operation is configured for indicating a status of an operation on the second character by the player or the device, for example, the player controls the second character to perform a running motion; or the device controls the second character to perform a diving motion.

In one embodiment, when reading the control operation for the second character, movement speed data, movement direction data, movement trajectory data, movement amplitude data, and the like of the second character are read.

Operation 730: Calculate a current movement and an animation.

For example, after reading movement data obtained from the control operation for the second character, the movement status of the second character is determined based on the movement data, and a movement animation corresponding to the second character is determined.

For example, the movement speed data, the movement direction data, the movement trajectory data, the movement amplitude data, and the like are integrated to determine the movement speed, the movement direction, the movement trajectory, and the like of the second character in the display screen of the second terminal. In one embodiment, when the second character is implemented as a person character, an animal character, or the like with joints, the extension statuses, the height statuses, and the like of different joints of the second character can also be determined based on the movement amplitude data and the like.

Operation 740: Whether synchronization is required.

For example, the main control terminal determines whether the second character needs to be synchronized to the simulation terminal. For example, when the main control terminal sends a synchronization request to the simulation terminal, the main control terminal determines that character synchronization is required based on the synchronization request; or when synchronization waiting duration of the main control terminal reaches preset duration, it is determined that character synchronization is required.

In one embodiment, when the main control terminal determines that character synchronization is required, the following operation 751 is performed; or when the main control terminal determines that character synchronization is not required, the following operation 752 is performed.

Operation 751: The main control terminal sends a phase and a phase change rate.

The phase is configured for indicating the second cycle parameter sent by the main control terminal to the simulation terminal.

In one embodiment, the second cycle parameter is implemented as a cycle parameter corresponding to the second object at the termination moment of the historical period of time, and the phase change rate is configured for indicating a cycle parameter change rate between the termination video frame corresponding to the termination moment and the previous video frame. To be specific, when determining the phase change rate, the termination video frame corresponding to the termination moment and the previous video frame adjacent to the termination video frame are first determined, the second cycle parameter corresponding to the termination video frame and the cycle parameter corresponding to the previous video frame are secondly determined, and the phase change rate is determined based on the difference between the cycle parameter corresponding to the previous video frame and the second cycle parameter and the corresponding duration of one frame.

Alternatively, the second cycle parameter is implemented as a cycle parameter corresponding to the second object at the designated moment after the termination moment of the historical period of time, and the phase change rate is configured for indicating a cycle parameter change rate between the designated video frame corresponding to the designated moment and the previous video frame.

For example, when the main control terminal determines that character synchronization is required, the main control terminal sends the phase and the phase change rate to the simulation terminal.

Operation 752: Perform a movement and an application action attitude.

For example, when the main control terminal determines that character synchronization is not required, the main control terminal controls, according to the calculated current movement status and animation corresponding to the second character, the second character to perform a movement action according to the movement status, and applies the determined animation, to control the second character to perform the corresponding action attitude.

The above examples are only illustrative. This is not limited in this embodiment of this disclosure.

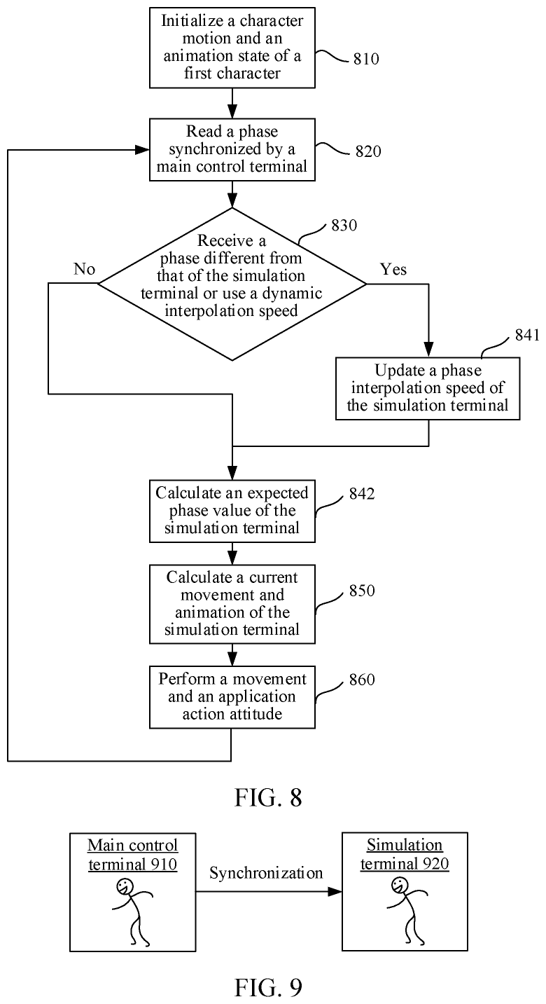

For example, as shown in FIG. 8, the above synchronous character display method can be implemented on the simulation terminal as the following operations 810 to 860.

Operation 810: Initialize a character motion and an animation state of a first character.

The simulation terminal is configured to instruct the first terminal to display the first character. In a gaming scenario or modeling scene, a plurality of devices (for example, a first terminal and a second terminal) enter the same scene. When a player or program controlling the second terminal controls the second character to perform an action in the screen displayed on the second terminal, the first terminal can synchronously present the action of the second character through a network. To be specific, the first terminal displays the first character corresponding to the second character on the first terminal based on the motion of the second character on the second terminal. The first character is a character obtained by synchronizing the second character, and the device that synchronizes the second character is defined as the simulation terminal (first terminal) of the character.

When character synchronization is performed through the above-mentioned synchronous character display method, the simulation terminal first initializes the character motion of the first character and initializes the animation state, to avoid interference from irrelevant factors to the character motion and the animation state.

Operation 820: Read a phase synchronized by a main control terminal.

For example, the simulation terminal receives the phase sent by the main control terminal, to read a phase value and a phase change rate synchronized by the main control terminal.

In one embodiment, the simulation terminal receives the phase value and the phase change rate that correspond to the first character at the termination moment of the historical period of time and that are sent by the main control terminal.

Operation 830: Receive a phase different from that of the simulation terminal or use a dynamic interpolation speed.

The determining of the phase (phase value) is associated with the standard action cycle of the first character.

In an embodiment, the standard action cycles of different types of characters (main control character or simulation character) are determined through the following standard action cycle determining rules as follows:
(1) For a character performing motion on a surface of an object, the standard action cycle of the character is determined using the following standard action cycle determining rule.

The surface of the object is configured for indicating the surface on which the virtual character can perform motion. For example, the surface of the object is implemented as a land surface, a cliff surface, a tree surface, an underwater surface, or a water surface relying on water surface tension. To be specific, the surface of the object not only can be implemented as a plane with a supporting function, but also can be implemented as a slope, a vertical surface, and the like. In addition, the surface of the object can be implemented as a smooth plane or a bumpy curved surface and other forms.

In an embodiment, description is made by using an example in which a character performs a bipedal walking/running motion on a plane. Based on the above motion process, a standard action cycle status corresponding to the bipedal walking/running motion is determined.

For example, the state in which the first foot is ready to start moving is used as the start state of a standard action cycle (cycle zero value), the state in which the first foot is raised to the highest point is used as the motion state corresponding to the ¼ cycle, the state in which the second foot starts moving is used as the motion state corresponding to the half cycle (half cycle value), the state in which the second foot is raised to the highest point is used as the motion state corresponding to the ¾ cycle, and the moment when the second foot is dropped to the ground is used as the termination state of a standard action cycle.

In an embodiment, description is made by using an example in which a character performs an overall body motion on a plane. Based on the above motion process, a standard action cycle status corresponding to the overall body motion is determined.

For example, the whole body motion is configured for indicating that all parts of the body as a whole perform a coordinated motion during motion. For example, the overall body motion is implemented as a bipedal jumping motion, a quadrupedal bounding motion, a body peristalsis motion, or another motion form. Based on the above motion process, a standard action cycle status corresponding to the bipedal jumping motion is determined.

For example, the state in which the feature state of the overall body begins to change significantly is used as the start state of a standard action cycle (cycle zero value). For example, when the overall body motion is implemented as a bipedal jumping motion, the cycle zero value of a standard action cycle is determined based on the character's bipedal take-off preparation state; or when the overall body motion is implemented as a quadrupedal bounding motion, the state in which the legs and knees of the character are ready to start to bend down is used as the start state of a standard action cycle; or when the overall body motion is implemented as a body peristalsis motion, the state in which the character's overall body begins to rise is used as the start state of a standard action cycle, for example, the state in which the front part of the body of a caterpillar (character) begins to rise is used as the start state of a standard action cycle, or the state in which the neck of a snake (character) begins to twist and shrink to one side and wait is used as the start state of a standard action cycle.

For example, an intermediate state in which the overall body has a significant half-cycle is used as an intermediate state of a standard action cycle, and the half-cycle value is determined based on the intermediate state. For example, when the overall body motion is implemented as a bipedal jumping motion, the state in which the character's body begins to soar after the two feet take off is used as the intermediate state of a standard action cycle, and the half-cycle value corresponding to the intermediate state is determined; or when the overall body motion is implemented as a quadrupedal bounding motion, the state in which the legs and knees of the character are bent to the maximum extent is used as the intermediate state of a standard action cycle; or when the overall body motion is implemented as a body peristalsis motion, the state in which the rear part of the overall body of the character begins to move is used as the intermediate state of a standard action cycle, for example, the state in which the front part of the caterpillar's body is dropped to the ground and then the rear part starts to move is used as the intermediate state of a standard action cycle.

In an embodiment, for a possible motion that is switched to a negative direction when there is significant symmetry in actions of the motion in opposite directions and the phase value is non-zero (for example, walking forward and walking backward are used as a motion in opposite directions), a positive direction of the motion is defined, and in the positive direction of the motion, the phase value of the motion increases; conversely, the negative direction of the motion is determined based on the positive direction of the motion, and in the negative direction of the motion, the phase value of the motion decreases.
(2) For a character performing motion in water, the standard action cycle of the character is determined using the following standard action cycle determining rule.

In one embodiment, an underwater creature is used as the above-mentioned character, or a creature that can perform motion in water is used as the above-mentioned character, and the standard action cycle of the character is determined. For example, the underwater creature is implemented as a fish, a shell, or another character.

For example, the process of determining the standard action cycle of a fish is used as an example for description. For a fish that relies on the tail fin for propulsion and other fins to maintain balance, the state in which the trunk is naturally extended is used as the start state of a standard action cycle, and this start state is used as the cycle zero value state; the state in which the tail fin swings to one side to the maximum extent is used as ¼ standard action cycle; the intermediate state in which the tail fin swings and recovers is used as the half-cycle motion state; the state in which the tail fin swings to the other side to the maximum extent is used as ¾ standard action cycle; the intermediate state in which the tail fin swings again and recovers is used as a completion state of a standard action cycle.

In one embodiment, a creature that can perform motion in water is used as the above-mentioned character, and the standard action cycle of the character is determined based on the motion status of the creature in water.

For example, for a character performing pectoral fin propulsion motion, rowing or swimming motion, and breaststroke motion, the state when the fins or paddles in the gliding-like state start to move forward is used as the cycle zero value state, and the state when reaching the maximum amplitude in front and preparing to press backward is used as a half-cycle value state; or the front and rear limbs of breaststroke can provide movement or driving alone or can be divided into a variety of different actions in combination with the animation of the driving or movement; or phase values are defined with reference to rowing or swimming, and in the animation combined with the driving, phases are defined with significant actions of a pair of limbs. In rowing or swimming, for pairs of paddles (fins) that perform motions alternately, refer to bipedal walking/running to define the phase; in rowing or swimming, if a plurality of paddles (fins) have no significant matching features, a phase value is individually defined for each (pair of) paddle (fin), and the motion animation of each (pair of) paddle (fin) is synchronized and calculated separately.

In one embodiment, a character that performs a water-absorbing motion is used as an example, and the state when starting absorbing water is used as the cycle zero-value state; the state when the water-absorbing is completed and spraying is ready to start is used as the half-cycle state.
(3) For a character performing motion in the air, the standard action cycle of the character is determined using the following standard action cycle determining rule.

For example, the flight motion in the air relying on wing flapping is similar to the rowing motion and the swimming motion in the water. In one embodiment, the state when the wings start to move forward is used as the cycle zero value state, and the state when the wings reach the maximum amplitude in front and preparing to flap backward is used as the motion state corresponding to the half cycle value.

The above examples are only illustrative. This is not limited in this embodiment of this disclosure.

In an embodiment, according to the status of determining the standard action cycle, the statuses of phase values corresponding to different frames in the standard action cycle are determined.

For example, after a standard action cycle is determined, assignment is performed on a special cycle value in the standard action cycle to determine a special phase value corresponding to the special cycle value.

After obtaining the special cycle value and the special phase value corresponding to the special cycle value, phase values corresponding to other cycle values in a standard action cycle that are different from the special cycle value are determined using an interpolation method.

For example, based on the features of the action, the computer program calculates frames in which the zero value, quarter cycle, half cycle, and three quarter cycle of the phase are located based on the extreme values of position and rotation changes of certain key skeleton nodes in the preceding and following frames, and sets corresponding phase values for different frames; or if the computer program cannot calculate the above special frames well, values are assigned to the manually marked special frames using the method of manually marking special frames, to obtain special phase values corresponding to the special frames.

In one embodiment, the computer program uses an interpolation method to assign values to non-special frames in a standard action cycle that are different from the special frames corresponding to the special cycle values, to obtain non-special phase values corresponding to the non-special frames.

In an embodiment, the definition of the phase value also defines the following rules to facilitate the processing of animation synchronization.

In one embodiment, similar attitudes defined in similar operating states based on the phase values of the same character are similar, and there is continuity between actions that can change each other. For example, assuming that the phase in which the right foot in running starts to be lifted and stepped forward is defined as a, the value of the phase in which the right foot starts to be lifted and stepped forward needs to be also defined as a in the walking action.

In one embodiment, the character's regular non-motion state phases are defined as special zero values, such as standing and gliding. When the phase value is zero, the current action can be determined based on the synchronization action type parameter. In an example, states with these special zero values can be only converted to animations with phase zero values or half-cycle values of other actions.

The above examples are only illustrative. This is not limited in this embodiment of this disclosure.

For example, after the simulation terminal receives the phase value, the phase value is compared with the phase value of the simulation terminal at the corresponding moment. When there is a difference between the phase value received by the simulation terminal and the phase value of the simulation terminal at the corresponding moment, the phase value of the simulation terminal at the corresponding moment is adjusted, so that the phase value of the simulation terminal becomes equal to the phase value sent by the main control terminal as soon as possible.

For example, by adjusting the dynamic interpolation speed, the phase value of the simulation terminal at the corresponding moment is adjusted, for example, increasing the dynamic interpolation speed to increase the adjustment speed of the phase value of the simulation terminal at the corresponding moment; or reducing the dynamic interpolation speed to reduce the adjustment speed of the phase value of the simulation terminal at the corresponding moment.

Operation 841: Update a phase interpolation speed of the simulation terminal.

For example, based on the adjustment of the dynamic interpolation speed, the phase interpolation speed of the simulation terminal is updated. For example, when the phase interpolation speed is increased, the phase values under different video frames can be determined faster, and the phase value of the simulation terminal can be made equal to the phase value sent by the main control terminal as soon as possible.

Operation 842: Calculate an expected phase value of the simulation terminal.

For example, based on the adjustment of the phase value of the simulation terminal, the expected phase value of the simulation terminal is determined. For example, the phase value of the simulation terminal is adjusted, so that the adjusted expected phase value is the same as the received phase value sent by the main control terminal.

Operation 850: Calculate an expected current movement and animation of the simulation terminal.

For example, after obtaining the expected phase value, the movement status corresponding to the expected phase value is calculated; or in the process of obtaining the expected phase value, the movement status corresponding to the adjusted phase value is calculated. Based on the adjustment of the phase value, the animation of the second character displayed on the simulation terminal is calculated.

Operation 860: Perform a movement and an application action attitude.

For example, after determining the action status of the second character and the animation of the second character displayed on the simulation terminal, the movement action performed by the second character on the simulation terminal is determined based on the action status of the second character; based on the animation status of the second character, the action attitude performed by the second character on the simulation terminal is determined.

The above examples are only illustrative. This is not limited in this embodiment of this disclosure.

In an embodiment, the above synchronous character display method is applied to a networked interactive gaming scenario or a virtual reality application scenario. For example, as shown in FIG. 9, a synchronous display process between a main control terminal 910 (second terminal) and a simulation terminal 920 (first terminal) is explained as follows.

For example, using an example in which the above synchronous character display method is applied to a networked interactive gaming scenario, a player controls the second character on the main control terminal 910, and the simulation terminal 920 controls, based on the player's control of the second character, the first character to perform actions corresponding to the second character; using an example in which the above synchronous character display method is applied to a virtual reality application scenario, the second character moves in a real scene and displays the movement process on the second terminal, the first terminal simulates, based on the movement status of the second character on the second terminal, the actions performed by the second character, displays the first character generated after simulating the second character on an interface, and controls the first character to perform actions corresponding to the second character.

The above examples are only illustrative. This is not limited in this embodiment of this disclosure.

In an embodiment, description is made by using an example in which the above synchronous character display method is applied to a networked interactive gaming scenario.

The main control terminal 910 calculates the currently played animation and the phase value of the current animation based on the operation by the player or a non-player character (NPC) and the action speed, action direction, animation type, historical action trajectory and phase value of the controlled character (second character) in the historical period of time, and calculates the change rate of the phase value.

The change rate of the phase value includes changes in the numerical magnitude of the phase value and changes in positive and negative trends. A positive value of the change rate indicates an increase in phase, for example, the second character moves forward; a negative value of the change rate indicates a decrease in phase, for example, the second character moves backward.

The main control terminal 910 regularly sends the phase value, the change rate of the phase value, and some related defined action parameters to the simulation terminal 920 together through a network. The related defined action parameters include position, orientation, speed, acceleration, and the like.

Based on the phase value of the previous iteration of the simulation character (the first character) and the received phase value of the main control terminal 910, the simulation terminal 920 adopts the method of speeding up and catching up or decelerating and waiting to make the phase value of the simulation terminal 920 quickly approach the phase value of the main control terminal 910 in a period of time in the future.

The phase value of the previous iteration is configured for indicating the phase value corresponding to the first character before the termination moment. After adjusting the action status of the first character through the phase value of the previous iteration, the phase value of the main control terminal 910 is received. For example, the phase value corresponding to the previous video frame before the termination moment is used as the phase value of the previous iteration; or the phase value corresponding to the previous second before the termination moment is used as the phase value of the previous iteration.

For example, after the main control terminal 910 sends the second cycle parameter at the termination moment of the historical period of time to the simulation terminal 920, the simulation terminal 920 obtains the phase value of the previous iteration, and compares the parameter value of the second cycle parameter with the parameter value of the first cycle parameter. When the parameter value of the first cycle parameter is less than the parameter value of the second cycle parameter, an acceleration and catch-up method is used, so that the phase value of the simulation terminal 920 quickly approaches the phase value of the main control terminal 910 in a period of time in the future; or when the parameter value of the first cycle parameter is greater than the parameter value of the second cycle parameter, a deceleration and waiting method is used, so that the phase value of the simulation terminal 920 quickly approaches the phase value of the main control terminal 910 in a period of time in the future.

The simulation terminal 920 then calculates an animation and a phase value of the simulation terminal 920 based on the parameters such as speed, direction, animation type, movement trajectory and phase value of the simulation character in the historical period of time, the received parameters such as position, speed, acceleration, current animation, and the phase value obtained through interpolation, the simulation terminal 920 plays an action attitude of the animation at the calculated phase value, thereby playing the simulation character on the simulation terminal 920. The simulation character is a synchronous display result for the main control character displayed on the main control terminal 910.

The above examples are only illustrative. This is not limited in this embodiment of this disclosure.

The phase value of the simulation terminal is not directly set to the phase value sent by the main control terminal. Instead, the original phase change speed of the simulation terminal is considered, and the local phase is expected to be consistent with the main control terminal at a moment in the future using an interpolation method. Phase interpolation manifests itself as fast catch-up or slow waiting. A reasonable interpolation fitting speed can make the animation of the simulation terminal coherently and smoothly consistent with the main control terminal, and can also combat the jitter of network data transmission.

In one embodiment, when the phase value synchronized by the main control terminal and the phase value of the current simulation terminal cross the phase zero value according to the direction of change (that is, the phase value synchronized by the main control terminal and the phase value of the simulation terminal are not within an action cycle), a standard action cycle is added (the phase change speed is positive) to or subtracted (the phase change speed is negative) from the phase value of the main control terminal, and the interpolation speed is calculated. When the phase value obtained by interpolation exceeds a cycle representation range, the phase value can also be standardized using this method of adding or subtracting a cycle value.

In an embodiment, a use time limit is set for calculating the updated interpolation speed to avoid a network jitter or packet loss problem that may cause an excessive error between the phase value of the simulation terminal and the phase value of the main control terminal due to a difference between change speeds.

In one embodiment, the above phase-based motion animation synchronization is also applicable in a client-server-client (C-S-C) mode with a dedicated server, the server is considered as the simulation terminal of the first client, the second client is considered as the simulation terminal of the server, and the server determines and executes the operation of sending synchronized phase data over the network before executing movement results and application action attitudes. In a case that good animation presentation is not required on the server, the server may not execute the interpolation catch-up logic and directly use the phase value of the main control terminal to calculate movements and actions.

To sum up, by obtaining the first cycle parameter of the first character at the termination moment of the historical period of time, the motion status of the first character in the standard action cycle can be considered, and the characteristic that the first character and the second character have the same standard action cycle can be fully used, so that when the first cycle parameter is adjusted by the first terminal based on the second cycle parameter, transition between action screens of the first character is smoother. In addition, because of the process of determining the second cycle parameter by the second terminal, the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

In this embodiment of this disclosure, in the process of character synchronization, the phase values (first cycle parameter and second cycle parameter) are used in the process of character synchronization, and the network simulation can be implemented, and the motion attitude of the character on the simulation terminal in the network can be highly consistent with that of the original control terminal by using a smaller amount of network data synchronization. In addition, the motion animation matches the motion trajectory, and the presentation is smooth and realistic, which not only can make the actions of the character on the simulation terminal quickly tend to be consistent with those on the main control terminal, but also can greatly reduce the sudden changes in actions brought about by factors such as network jitter, so that the synchronously displayed animation of the character on the simulation terminal is more stable and natural.

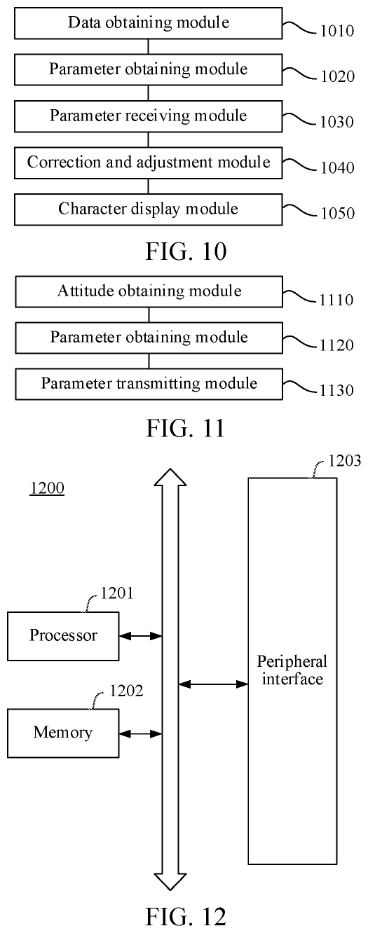

FIG. 10 is a structural block diagram of a synchronous character display apparatus according to an embodiment of this disclosure. As shown in FIG. 10, the apparatus includes the following parts:
a data obtaining module 1010, configured to obtain simulation attitude data of a first character in a historical period of time, the first character being a character that is displayed in a first terminal in synchronization with a second character mainly controlled by a second terminal;
a parameter obtaining module 1020, configured to obtain, based on the simulation attitude data and a motion status of the first character in a standard action cycle corresponding to a current action, a first cycle parameter corresponding to the first character at a termination moment of the historical period of time, the first cycle parameter being configured for indicating a state feature corresponding to an action presentation of the first character at the termination moment in the standard action cycle;
a parameter receiving module 1030, configured to receive a second cycle parameter that corresponds to the second character at the termination moment and that is transmitted by the second terminal, the second cycle parameter being configured for indicating a state feature corresponding to an action presentation of the second character at the termination moment in the standard action cycle;
a correction and adjustment module 1040, configured to perform correction and adjustment on the first cycle parameter based on the second cycle parameter, to obtain an adjusted third cycle parameter; and
a character display module 1050, configured to generate, based on the third cycle parameter, updated attitude data corresponding to the termination moment, and display, based on the updated attitude data, the first character corresponding to the second character.

In an embodiment, the parameter obtaining module 1020 is further configured to perform the operations related to obtaining the first cycle parameter shown in the above embodiments of FIG. 2 and FIG. 5.

In an embodiment, the correction adjustment module 1040 is further configured to perform the operation related to adjusting the first cycle parameter shown in the above embodiment of FIG. 6.

FIG. 11 is a structural block diagram of a synchronous character display apparatus according to another embodiment of this disclosure. The apparatus is applied to a second terminal. As shown in FIG. 11, the apparatus includes the following parts:
an attitude obtaining module 1110, configured to obtain main control attitude data of a second character in a historical period of time, the second character being a character mainly controlled by the second terminal;
a parameter obtaining module 1120, configured to obtain, based on the main control attitude data and a motion status of the second character in a standard action cycle corresponding to a current action, a second cycle parameter corresponding to the second character at a termination moment of the historical period of time, the second cycle parameter being configured for indicating a state feature corresponding to an action presentation of the second character at the termination moment in the standard action cycle; and
a parameter transmitting module 1130, configured to transmit the second cycle parameter to a first terminal, the first terminal being configured to perform synchronization on the second character and display a first character corresponding to the second character,
the first terminal performing, based on the second cycle parameter, correction and adjustment on a first cycle parameter, to obtain an adjusted third cycle parameter, the first cycle parameter being configured for indicating a state feature corresponding to an action presentation of the first character at the termination moment in the standard action cycle; and the first terminal generating, based on the third cycle parameter, updated attitude data corresponding to the termination moment, and displaying, based on the updated attitude data, the first character corresponding to the second character.

To sum up, Simulation attitude data of a first character in a historical period of time is obtained, and a first cycle parameter of the first character at a termination moment of the historical period of time is obtained in combination with a motion status of the first character in a standard action cycle of a current action; correction and adjustment are performed on the first cycle parameter based on a second cycle parameter transmitted by a second terminal, to obtain a third cycle parameter; updated attitude data is generated based on the third cycle parameter; and the first character corresponding to a second character is displayed according to the updated attitude data.

Through the foregoing method, the motion status of the first character in the standard action cycle of the current action can be considered, and the characteristic that the first character and the second character have the same action cycle can be fully used. The first cycle parameter is adjusted on the first terminal based on the second cycle parameter, to make transition between action screens of the first character smoother.

In addition, the second terminal transmits the second cycle parameter to the first terminal, and the second terminal does not need to transmit all action data to the first terminal, thereby effectively reducing the amount of data transmitted between the first terminal and the second terminal, to not only improve a character motion smoothing effect, but also improve data transmission efficiency in a character synchronization process.

FIG. 12 is a structural block diagram of an electronic device 1200 according to an embodiment of this disclosure. The electronic device 1200 may be a portable mobile terminal such as a smartphone, an on-board terminal, a tablet computer, a Moving Picture Experts Group Audio Layer III (MP3) player, a Moving Picture Experts Group Audio Layer IV (MP4) player, a notebook computer, or a desktop computer. The electronic device 1200 may also be referred to as another name such as user equipment, a portable terminal, a laptop terminal, or a desktop terminal.

The electronic device 1200 includes a processor 1201 (e.g., processing circuitry) and a memory 1202 (e.g., a non-transitory computer-readable storage medium).

The processor 1201 may include one or more processing cores, for example, a 4-core processor or an 8-core processor. The processor 1201 may be implemented in at least one hardware form of a digital signal processor (DSP), a field-programmable gate array (FPGA), and a programmable logic array (PLA). The processor 1201 may also include a main processor and a coprocessor. The main processor is a processor configured to process data in an awake state, and is also referred to as a central processing unit (CPU). The coprocessor is a low power consumption processor configured to process the data in a standby state. In some embodiments, the processor 1201 may be integrated with a graphics processing unit (GPU). The GPU is configured to render and draw content that needs to be displayed on a display screen. In some embodiments, the processor 1201 may further include an artificial intelligence (AI) processor. The AI processor is configured to process computing operations related to machine learning.

The memory 1202 may include one or more computer-readable storage media. The computer-readable storage medium may be non-transient. The memory 1202 may further include a high-speed random access memory and a nonvolatile memory, for example, one or more disk storage devices or flash storage devices. In some embodiments, the non-transitory computer-readable storage medium in the memory 1202 is configured to store at least one instruction, and the at least one instruction being configured to be executed by the processor 1201 to implement the synchronous character display method provided in the method embodiments of this disclosure.

In some embodiments, the electronic device 1200 may include a peripheral device interface 1203 and at least one peripheral device.

A person skilled in the art may understand that the structure shown in FIG. 12 constitutes no limitation on the electronic device 1200, and the terminal may include more or fewer components than those shown in the figure, or some components may be combined, or a different component deployment may be used.

An embodiment of this disclosure further provides a computer device. The computer device may be implemented as the terminal or server shown in FIG. 2. The computer device includes a processor and a memory. The memory has at least one instruction, at least one program, a code set, or an instruction set stored therein, and the at least one instruction, the at least one program, the code set, or the instruction set is loaded and executed by the processor to implement the synchronous character display method according to the foregoing method embodiments.

The embodiments of this disclosure further provide a computer-readable storage medium, such as a non-transitory computer-readable storage medium. The computer-readable storage medium has at least one instruction, at least one program, a code set, or an instruction set stored therein, and the at least one instruction, the at least one program, the code set, or the instruction set is loaded and executed by the processor to implement the synchronous character display method according to the foregoing method embodiments.

An embodiment of this disclosure further provides a computer program product or computer program. The computer program product or computer program includes computer instructions, and the computer instructions are stored in a computer-readable storage medium. A processor of a computer device reads the computer instruction from the computer-readable storage medium, and the processor executes the computer instruction, to cause the computer device to perform the synchronous character display method according to any one of the foregoing embodiments.

What is claimed is:

1. A method for synchronizing character display, the method comprising:
obtaining motion data of a first character over a time period, the first character being displayed by a first terminal in synchronization with a second character controlled by a second terminal;
determining a first phase parameter for the first character at an end of the time period based on the motion data and a standard action cycle for a current action that is performed by the first character, the standard action cycle indicating a complete sequence of motions for a specific action, and the first phase parameter indicating a state feature corresponding to an action presentation of the first character at the end of the time period within the standard action cycle;
receiving a second phase parameter from the second terminal, the second phase parameter corresponding to the second character at the end of the time period, the second phase parameter indicating the state feature corresponding to the action presentation of the second character within the standard action cycle at the end of the time period;
adjusting the first phase parameter based on the second phase parameter to obtain a third phase parameter;
generating updated motion data for the first character based on the third phase parameter; and
displaying the first character based on the updated motion data.

2. The method according to claim 1, wherein the determining the first phase parameter comprises:
obtaining cycle motion data for the first character in the standard action cycle, the cycle motion data indicating an action execution status of the specific action being performed by the first character;
assigning parameter values to video frames of the first character in the time period based on the motion data and the cycle motion data; and
determining the first phase parameter from a parameter value of an end video frame of the video frames in the time period.

3. The method according to claim 2, wherein the assigning the parameter values comprises:
obtaining key point position data from the motion data, the key point position data indicating position changes of predefined key points of the first character;
determining reference key point data for the standard action cycle;
assigning the parameter values to the reference key point data; and
assigning the parameter values to the video frames based on a comparison of the key point position data to the reference key point data to assign the parameter values to the video frames.

4. The method according to claim 3, wherein the assigning the parameter values to the reference key point data comprises:
determining a cycle start time and a cycle end time in the standard action cycle;
assigning a start parameter value to the reference key point data at the cycle start time;
assigning an end parameter value to the reference key point data at the cycle end time;
obtaining intermediate reference data for at least one intermediate time between the cycle start time and the cycle end time; and
interpolating at least one parameter value for the intermediate reference data.

5. The method according to claim 4, wherein the interpolating the at least one parameter value comprises:
selecting a designated intermediate time between the cycle start time and the cycle end time;
determining a first time interval between the designated intermediate time and the cycle start time;
determining a second time interval between the designated intermediate time and the cycle end time; and
calculating an interpolated parameter value for the designated intermediate time based on the first time interval, the second time interval, the start parameter value, and the end parameter value.

6. The method according to claim 1, wherein the adjusting the first phase parameter comprises:
determining an adjustment rate by adjusting a change rate of the first phase parameter over a temporal sequence based on a parameter value change range of the second phase parameter over the temporal sequence; and
applying the adjustment rate to the first phase parameter to obtain the third phase parameter.

7. The method according to claim 6, wherein the determining the adjustment rate includes adjusting an interpolation calculation rate based on the parameter value change range of the second phase parameter, and the interpolation calculation rate indicates a rate at which the first phase parameter is adjusted to obtain the third phase parameter.

8. The method according to claim 7, wherein the adjusting the interpolation calculation rate comprises:
increasing the interpolation calculation rate to increase the adjustment rate; or
decreasing the interpolation calculation rate to decrease the adjustment rate.

9. The method according to claim 1, wherein the adjusting the first phase parameter comprises:
increasing a change rate of the first phase parameter when a parameter value change range of the second phase parameter is greater than a parameter value change range of the first phase parameter; or
decreasing the change rate of the first phase parameter when the parameter value change range of the second phase parameter is less than the parameter value change range of the first phase parameter.

10. A method for synchronizing character display, the method comprising:
obtaining motion data of a second character over a time period;
determining, by processing circuitry of a second terminal, a second phase parameter for the second character at an end of the time period based on the motion data and a standard action cycle for a current action that is performed by the second character; and
transmitting the second phase parameter to a first terminal, wherein the first terminal adjusts a first phase parameter based on the second phase parameter to synchronize display of a first character corresponding to the second character.

11. The method according to claim 10, wherein the determining the second phase parameter comprises:
obtaining cycle motion data for the second character in the standard action cycle;
assigning parameter values to video frames of the second character in the time period based on the motion data and the cycle motion data; and
determining the second phase parameter from a parameter value of an end video frame of the video frames in the time period.

12. The method according to claim 11, wherein the assigning the parameter values comprises:
obtaining key point position data from the motion data;
determining reference key point data for the standard action cycle;
assigning the parameter values to the reference key point data; and
assigning the parameter values based on a comparison of the key point position data to the reference key point data.

13. The method according to claim 12, wherein the assigning the parameter values to the reference key point data comprises:
determining a cycle start time and a cycle end time in the standard action cycle;
assigning a start parameter value to the reference key point data at the cycle start time;
assigning an end parameter value to the reference key point data at the cycle end time obtaining intermediate reference data for at least one intermediate time between the cycle start time and the cycle end time; and
interpolating at least one parameter value for the intermediate reference data.

14. The method according to claim 13, wherein the interpolating the at least one parameter value comprises:
selecting a designated intermediate time between the cycle start time and the cycle end time;
determining a first time interval between the designated intermediate time and the cycle start time;
determining a second time interval between the designated intermediate time and the cycle end time; and
calculating an interpolated parameter value for the designated intermediate time based on the first time interval, the second time interval, the start parameter value, and the end parameter value.

15. The method according to claim 10, further comprising:
transmitting a parameter value change range of the second phase parameter over a temporal sequence to the first terminal, wherein the first terminal determines an adjustment rate by adjusting a change rate of the first phase parameter based on the parameter value change range of the second phase parameter, and applies the adjustment rate to the first phase parameter.

16. An apparatus, comprising:
processing circuitry configured to:
obtain motion data of a first character over a time period, the first character being displayed by a first terminal in synchronization with a second character controlled by a second terminal;
determine a first phase parameter for the first character at an end of the time period based on the motion data and a standard action cycle for a current action that is performed by the first character, the standard action cycle indicating a complete sequence of motions for a specific action, and the first phase parameter indicating a state feature corresponding to an action presentation of the first character at the end of the time period within the standard action cycle;
receive a second phase parameter from the second terminal, the second phase parameter corresponding to the second character at the end of the time period, the second phase parameter indicating the state feature corresponding to the action presentation of the second character within the standard action cycle at the end of the time period;
adjust the first phase parameter based on the second phase parameter to obtain a third phase parameter;
generate updated motion data for the first character based on the third phase parameter; and
display the first character based on the updated motion data.

17. The apparatus according to claim 16, wherein the processing circuitry is configured to:
obtain cycle motion data for the first character in the standard action cycle, the cycle motion data indicating an action execution status of the specific action being performed by the first character;
assign parameter values to video frames of the first character in the time period based on the motion data and the cycle motion data; and
determine the first phase parameter from a parameter value of an end video frame of the video frames in the time period.

18. The apparatus according to claim 17, wherein the processing circuitry is configured to:
obtain key point position data from the motion data, the key point position data indicating position changes of predefined key points of the first character;
determine reference key point data for the standard action cycle;
assign the parameter values to the reference key point data; and
assign the parameter values to the video frames based on a comparison of the key point position data to the reference key point data to assign the parameter values to the video frames.

19. The apparatus according to claim 18, wherein the processing circuitry is configured to:
determine a cycle start time and a cycle end time in the standard action cycle;
assign a start parameter value to the reference key point data at the cycle start time;
assign an end parameter value to the reference key point data at the cycle end time;
obtain intermediate reference data for at least one intermediate time between the cycle start time and the cycle end time; and
interpolate at least one parameter value for the intermediate reference data.

20. The apparatus according to claim 19, wherein the processing circuitry is configured to:
select a designated intermediate time between the cycle start time and the cycle end time;
determine a first time interval between the designated intermediate time and the cycle start time;
determine a second time interval between the designated intermediate time and the cycle end time; and
calculate an interpolated parameter value for the designated intermediate time based on the first time interval, the second time interval, the start parameter value, and the end parameter value.
